(19) United States
(12) Patent Application Publication
(10) Pub. No.: US 2018/0230903 A1
(43) Pub. Date: Aug. 16, 2018

(54) HYBRID COMBUSTION TURBINE POWER PLANT

(71) Applicant: ENERGY TECHNOLOGIES INSTITUTE LLP, Leicestershire (GB)

(72) Inventor: James MACNAGHTEN, Emsworth Hampshire (GB)

(21) Appl. No.: 15/749,262

(22) PCT Filed: Aug. 10, 2016
(86) PCT No.: PCT/GB2016/052486

§ 371 Date: Jan. 31, 2018

(30) Foreign Application Priority Data
Aug. 12, 2015 (GB) 1514338.1
Oct. 29, 2015 (GB) 1519149.7

(51) Int. Cl. F02C 6/16; F02C 6/18; F02C 9/18; F28D 17/00; F28D 17/02; F28D 20/00

(52) U.S. Cl. CPC F02C 6/16; F02C 6/18; F02C 9/18; F28D 17/005; F05D 2260/606; F28D 20/0056; F05D 2220/7642; F05D 2240/124; F05D 2260/42; F28D 17/02

(57) ABSTRACT

Some embodiments are directed to a hybrid combustion turbine power generation system, which includes a gas turbine integrated with an ACAES via fluid connection(s) between the compressor and turbine , to allow air to be extracted from, and injected into, the gas turbine, the ACAES including a direct TES and compressed air store , a top-up compressor being disposed between the fluid connection(s) and the direct TES and fluidly connected so that its inlet receives air extracted from the gas turbine in an extraction mode and its outlet sends air at a higher temperature and pressure towards the downstream direct TES , thereby optimising the temperature at which returning air is injected into the gas turbine in an injection mode. This may extend the operational power range of the gas turbine and address changes in the gas turbine operating conditions between injection and bleed modes.

### CROSS REFERENCE TO RELATED APPLICATIONS

This application is a national phase filing under 35 C.F.R. § 371 of and claims priority to PCT Patent Application No. PCT/GB2016/052486, filed on Aug. 10, 2016, which claims the priority benefit under 35 U.S.C. § 119 of British Patent Application No. 1519419.7, filed on Oct. 29, 2015; and of British Patent Application No. 1514338.1, filed on Aug. 12, 2015, the contents of each of which are hereby incorporated in their entireties by reference.

### BACKGROUND

Some embodiments relate to a hybrid combustion turbine power generation system, and a method of operation. In particular, some embodiments are concerned with a hybrid system in which an adiabatic compressed air energy storage (ACAES) system is integrated with a conventional combustion turbine via one or more fluid connections so as to allow air to be extpracted from, and injected into, the combustion turbine during operation thereof.

CAES systems utilizing thermal energy storage (TES) apparatus to store heat have been known since the 1980's. In particular, ACAES systems store the heat of compression of the compressed air in thermal stores for subsequent return to the air as it leaves the compressed air store before undergoing expansion.

The TES may be a direct thermal transfer TES apparatus or “direct TES” and this may contain a gas permeable, solid thermal storage medium (e.g. porous mass) through which the compressed air passes, releasing heat directly to the storage medium, thereby heating the storage medium and cooling the air. The medium may be a packed bed of solid particles through which the air passes exchanging thermal energy directly, or, it may include a solid matrix or monolith provided with channels or interconnecting pores extending therethrough.

Alternatively, the TES may be an indirect thermal transfer TES apparatus or “indirect TES”, where the compressed air instead passes through a heat exchanger and the heat is transferred indirectly to a thermal storage medium, for example, via an intermediate heat transfer fluid to a separate thermal store coupled to the heat exchanger; in the latter case, the thermal store itself need not be pressurised and could include a thermal storage medium such as a molten salt or high temperature oil.

It will be appreciated that where the storage of sensible heat in the TES apparatus is optimised, then the overall energy storage capacity of an ACAES will also be enhanced. Thermal energy stores based on direct thermal transfer have much higher efficiencies than ones that store heat indirectly (e.g. usually involving heat exchangers coupled to remote stores via heat transfer fluid loops). Applicant's earlier application WO2012/127178 proposes direct thermal transfer TES apparatus wherein the storage media is divided up into separate respective downstream sections or layers. The flow path of the heat transfer fluid through the layers can be selectively altered using valving in the layers so as to access only certain layers at selected times, so as to avoid pressure losses through inactive sections upstream or downstream of the sections where the thermal front is located and to maximise store utilisation. TES apparatus incorporating layered storage controlled by valves (more particularly, direct thermal transfer, sensible heat stores incorporating a gas permeable, solid thermal storage medium disposed in respective, downstream, individually access controlled layers) can provide very efficient storage of heat up to temperatures of 600° C. or even hotter. It should be noted that the flow velocity through such a bed may be as low as 0.5 m/s or even lower, promoting efficient thermal exchange.

Air injected power augmentation of combustion turbines is used to increase the power output of a gas turbine up to its normal maximum allowable power where, for example, the power has dropped due to high altitude or high ambient temperatures reducing the density of inlet air. Externally compressed, heated air is injected into the gas turbine upstream of the combustor in order to improve the power output.

U.S. Pat. No. 5,934,063 to Nakhamkin proposes a hybrid combustion turbine power generation system (CTPGS) in which a gas turbine (GT) is integrated with an ACAES system and pressurised air from the air storage is injected at the combustor to augment the air flow through the gas turbine and hence increase the power output when it would otherwise be below its maximum allowable level. A supplemental compressor with its own air inlet supplies the air to the air storage, or, that supplemental compressor is fed by the main compressor (while the combustor is unfired and the turbine merely receives a cooling flow from the air store). This system has valve structure that selectively permits each of the following modes of operation: a normal gas turbine power generation mode, an augmented gas turbine power generation mode, and a storage mode.

According to WO2013/116185, U.S. Pat. No. 5,934,063 has not been implemented because it is high in cost and complexity and lacks a practical method to heat the air up prior to injection after storage. The teaching in U.S. Pat. No. 5,934,063 is either to preheat the returning stored air with waste heat from the turbine (in the case of a Simple Cycle Gas Turbine SCGT), or waste heat from a steam turbine (in the case of a Combined Cycle Gas Turbine CCGT), either of which cause an efficiency penalty at the turbine concerned. As an alternative, WO2013/116185 instead proposes, inter alia, the use of various heat exchanger stages during the storage mode to store the heat of compression for subsequent return. It also proposes a storage mode in which some pressurised gas is extracted from the gas flow passing down through the gas turbine while it is operating and producing power otherwise normally.

As a related matter, there have also been various proposals to provide a combustion turbine (GT) system integrated with an adiabatic compressed air energy storage ACAES system, with a decoupling device such that the compressor may be selectively coupled and decoupled from the turbine in order to allow their independent operation such that the gas turbine can operate in multiple modes; selector valve arrangements may be disposed within the GT flow path to divert the airflow into and out of the GT in these multiple modes. However, to date no commercial systems exist due to the cost and complexity of developing such a decouplable gas turbine system.

An industrial gas turbine used for power generation is normally coupled to the electric grid via a synchronous electric generator. The electric generator can only rotate at a fixed speed and consequently the gas turbine is fixed speed. This means that the volume of air that the compressor of the gas turbine ingests is approximately fixed regardless of air temperature. Inlet Guide Vanes are normally connected to the compressor to allow the volume of air that is ingested to be changed. They are normally in an open position at full power (maximum volume ingested) and closed at minimum load (minimum volume ingested). However, they can normally be set at any position between fully open and fully closed to allow for a different volume of air to be ingested. The variation in volumetric (and hence mass flow rate) flow rate goes from 100% mass flow rate at fully open to around 70% mass flow rate at fully closed in most normal industrial gas turbines. At the 70% mass flow rate the turbine inlet temperature can also be lowered (from the 100% setting) so that the power output of the gas turbine is normally reduced to around 35% of full power. When combined with a steam plant to create a CCGT the power output is approximately 40% of full power. The lower limit on power generation is normally set by local emissions standards. If insufficient fuel is combusted and the turbine inlet temperature drops too low there can be a significant increase in CO emissions. Were it not for these emissions limits many gas turbines could turn down below 40%.

### SUMMARY

If a gas turbine of normal arrangement (i.e. permanently coupled compressor and turbine) is integrated with an ACAES system configured for bleed and injection modes whilst the GT is operating (e.g. to generate power), those modes will usually occur at or close to minimum load and maximum load, respectively. However, the difference in typical mass flow rate in the gas turbine between operation in the injection mode and bleed mode, means that the gas turbine operating conditions in the pre-combustor region (i.e. compressor outlet conditions) are likely to drop from, say, 450° C. and 18 bar in the injection m ode to about, say, 380° C. and 12 bar in the bleed mode. Where the ACAES involves a direct TES for respectively storing heat from the extracted air on its way to storage in a compressed air store, and returning the heat to that air as it returns from storage, there will be the problem that the TES returns stored heat that is of too low a temperature having regard to the current higher operating temperatures and pressures in the gas turbine. Hence, either additional fuel (or other forms of heating) will be required in order to heat the gas up to an acceptable temperature before injection into the gas turbine, or, for example, a boost compressor (that draws power) will be required to raise the air temperature and pressure back up to the (e.g. maximum load) conditions, or otherwise, the air has to be added at non-optimum condition causing irreversible thermal mixing and loss of turbine efficiency.

It should further be noted that if, during the bleed mode, the (part-load) turn-down capability of a gas turbine plant, particularly a Combined Cycle Gas Turbine (CCGT) plant, could be extended, and/or if, in the injection mode, the full load turn-up capability of the gas turbine plant could be extended, that would be highly desirable both for economic and grid reasons.

First Aspect

According to a first aspect, some embodiments are directed to a hybrid combustion turbine power generation system (CTPGS) including:

a combustion turbine (GT) system including a first compressor, a combustor and a turbine fluidly connected downstream of each other, wherein the turbine and compressor are coupled on a drive shaft and operatively associated with a generator or motor/generator,

and an adiabatic compressed air energy storage system (ACAES) integrated therewith via one or more fluid connections disposed between the compressor and turbine, so as to allow air to be extracted from (in a bleed mode), and injected into (in an injection mode), the GT system;

wherein the ACAES includes a flow passageway network and associated valve structure leading from the one or more fluid connections to a compressed air store via a first direct thermal energy store (TES); and,

wherein a top-up compressor is disposed in the flow passageway network between the one or more fluid connections and the direct TES, and is so fluidly connected that its inlet receives air extracted from the GT system and its outlet sends (outlet) air at a higher temperature and pressure (than the inlet air) towards the downstream direct TES.

Incorporation of a compressor (identified as the “top-up compressor”) before the first direct TES permits the temperature and pressure of the air to be topped-up before it enters the direct heat transfer thermal store. As a result, during a subsequent injection mode, air emerging from the direct TES has a higher temperature than would otherwise be the case, which is beneficial for the receiving GT system. Other benefits are described more fully below and include extending the operational power range of the GT and delivery of the air to subsequent stages of the power machinery at a higher pressure than would otherwise be the case.

The flow passageway network and associated valve structure are configured to allow selective operation of the hybrid CTPGS in (i) a bleed mode, that is, in which some air is extracted via the one or more fluid connections from air passing respectively downstream through the compressor, combustor and turbine of the GT system as it operates, the extracted air being supplied to the compressed air store of the ACAES system via the direct TES; and, (ii) an injection mode, that is, in which air passing respectively downstream through the compressor, combustor and turbine of the GT system as it operates is supplemented by the injection, at the one or more fluid connections, of pressurised air that is returning from the compressed air store of the ACAES system via the direct TES.

The ACAES may further include a charging compressor, having an associated (external/atmospheric) air inlet, that is fluidly connected upstream of the top-up compressor, such that an outlet of the charging compressor outlet sends compressed air towards an inlet of the top-up compressor for charging the compressed air store in a charge mode. Thus, the charging compressor and top-up compressor are disposed in series allowing them successively to compress external air before it enters the direct TES.

This embodiment has a higher initial cost and requires additional power (e.g. a motor operatively associated with the charging compressor), but it allows compressed air to be supplied to the top-up compressor by extraction from the GT system, or, from the charging compressor, or, from both of those compressors, providing the mass flow rate does not exceed the maximum mass flow rate of the top-up compressor.

The charging compressor will usually be configured to operate over a similar or lower pressure ratio to that (e.g. the maximum operating pressure ratio) of the first compressor.

Usually, it will operate over roughly the same pressure ratio as the first compressor would be operating over when in a bleed mode (e.g. a lower pressure ratio such as one the same as, or less than, the normal pressure ratio at minimum load standard running). However, the charging compressor only needs to be sized with a maximum power rating to match the top-up compressor.

The charging compressor outlet may be directly connected by pipework to the top-up compressor inlet, or it may be connected indirectly via pipework that intersects the flow passageway network at a point disposed between the fluid connections and the top-up compressor.

When a charging compressor is present, the flow passageway network and associated valve structure may be configured to allow selective operation in one or more of charging modes (i) to (iv) below:

i) the charging compressor is active and the GT system is inactive;

ii) the charging compressor is active and the GT system is active, but there is no bleeding of air from the GT system;

iii) the charging compressor is active and the GT system is active with some bleeding of air from the GT system so that the top-up compressor receives compressed air from both the first compressor and the charging compressor; and,

iv) the charging compressor is inactive and the GT system is active with bleeding of air from the GT system.

The flow passageway network and associated valve structure may also be configured to allow air successively compressed by the charging compressor and top-up compressor to be sent back up to the flow connectors for injection into the gas turbine, for example, when the compressed air store is empty. This may be achieved by a flow pathway as described immediately below.

The flow passageway network usually includes an alternative (e.g. parallel) flow pathway that allows flow to bypass the top-up compressor, thereby allowing air returning from storage to bypass the top-up compressor. That pathway may further include a flow control valve to control the mass flow rate therein.

Second (i.e. higher pressure) stage power machinery is usually provided in the flow passageway network between the direct TES and the compressed air store; that machinery and an optional second thermal energy store (TES) may be arranged successively downstream of one another in the flow passageway network between the direct TES and the compressed air store.

The second stage power machinery may include a compressor (or a reversible compressor/expander) and a pressure reducing device (that does no useful work) disposed in alternative (e.g. parallel) respective flow pathways (for use in bleed and injection modes, respectively) between the at least one direct TES and the compressed air store. If the heat of compression is not being stored for subsequent return, one flow pathway may include a compressor provided with one or more intercooling stages and an optional aftercooler. Alternatively, that one flow pathway may include a reversible compressor/expander and at least one thermal energy store successively downstream of one another between the first TES and compressed air store.

By “pressure reducing device” is meant a device that allows air to expand without doing work as it emerges from the compressed air store. Such a device is simple and relatively low cost and may be a throttle valve, expansion valve or similar device. The device should ideally regulate mass flow through it (or, for example, be followed (e.g. immediately downstream) by a device that regulates mass flow) to avoid uncontrolled mass flow.

In a preferred first aspect, some embodiments are directed to a hybrid combustion turbine power generation system (CTPGS) including:

a combustion turbine (GT) system including a first compressor (the “GT compressor”), a combustor and a turbine fluidly connected downstream of each other, wherein the turbine is non-detachably coupled to the compressor and is operatively associated with a generator or motor/generator for power generation;

and an adiabatic compressed air energy storage system (ACAES) integrated therewith via one or more fluid connections located in the vicinity of the compressor and/or combustor, so as to allow air to be extracted from, and injected into, the air flowing through the GT system;

wherein the ACAES includes a flow passageway network and associated valve structure leading from the one or more fluid connections to a compressed air store via a first direct thermal transfer, thermal energy store (direct TES);

wherein a top-up compressor is disposed in the flow passageway network between the one or more fluid connections and the direct TES, and is so fluidly connected that its inlet receives (e.g. all the) air extracted from the GT system and its outlet sends (outlet) air at a higher temperature and pressure (than the inlet air) towards the downstream direct TES,

wherein a second (higher pressure) stage power machinery and an optional second thermal energy store (TES) are arranged successively downstream of one another in the flow passageway network between the direct TES and the compressed air store: and,

wherein the flow passageway network and associated valve structure is configured to allow selective operation of the hybrid CTPGS in each of the following modes:

(i) a bleed mode (i.e. charge mode) in which some air is extracted via the one or more fluid connections from air passing respectively downstream through the compressor, combustor and turbine of the GT system as it operates (e.g. to generate power), the extracted air being supplied to the compressed air store of the ACAES system via the direct TES; and,

(ii) an injection mode (i.e. discharge mode) in which air passing respectively downstream through the compressor, combustor and turbine of the GT system as it operates (e.g. to generate power) is supplemented by the injection, at the one or more fluid connections, of pressurised air that is returning from the compressed air store of the ACAES system via the direct TES.

Incorporation of a compressor (identified as the “top-up compressor”) before the first direct TES to top-up the temperature and pressure of the air before it enters the direct heat transfer thermal store has a number of important benefits.

One benefit is that it can mitigate the problem of the changing gas turbine operating conditions in the pre-combustor region (i.e. GT compressor outlet conditions) between operation in the injection mode and bleed mode. The gas turbine operating conditions in the pre-combustor region are likely to drop from, say, 450° C. and 18 bar in the injection mode (likely to be used at or near maximum load) to about, say, 380° C. and 12 bar in the bleed mode (likely to be used near minimal load). This would normally mean that in the bleed mode the direct TES will receive and store heat that is at too low a temperature having regard to the higher operating temperatures and pressures used in the injection mode. Hence, either additional fuel (or other forms of heating) will be required in order to heat the gas up to an acceptable temperature before injection into the gas turbine, or, for example, a boost compressor (that draws power) will be required to raise the air temperature and pressure back up to the (max load) conditions, or otherwise, the air has to be added at non-optimum condition causing irreversible thermal mixing and loss of turbine efficiency. The top-up compressor may be used to increase the temperature at which thermal energy is stored in the direct TES in the bleed mode, so that it may be optimal for injection back into the GT combustor during the injection mode, for example, matching or exceeding the GT operating temperature in the pre-combustor region.

A further benefit is that use of the top-up compressor upstream of the second stage machinery in the bleed mode means that the second stage compressor is compressing air that starts at a higher initial pressure, but that usually will have been cooled by a heat exchanger downstream of the direct TES so as to be back to nearly ambient. Hence, for a selected pressure ratio (hence same amount of work), the second and any subsequent stage power machinery may generate a much higher final pressure in the compressed air store leading to improved storage density and the possibility of using a smaller volume compressed air store. (If a second TES is being used in any stage to store the heat of that subsequent compression, that TES will usually be the limiting factor on how much compression can be undertaken in any one stage e.g. up to 250° C..)

Another significant benefit is that use, in the bleed mode, of a top-up compressor can increase the flexibility of the GT by extending the turn-down capability (reduction in output power) during the bleed mode (e.g. a bleed mode where the inlet guide vanes are open, partially open or even closed) by itself drawing additional power. There can be significant economic benefits in extending the power range/flexibility of a gas turbine, particularly a CCGT plant where it is difficult to switch the plant on and off. This may occur because the start and stop time are quite long and the periods that the plant would be switched off are only quite short or where the impact on the life of the plant is negatively affected by too many start/stop cycles.

The top-up compressor may be an axial flow, centrifugal, reciprocating piston or turbo-compressor.

The “bleed mode”, in which air is being extracted via the one or more fluid connections from an air flow passing successively downstream through the compressor, combustor and turbine, respectively, of the GT system, may alternatively be referred to as a “charge mode” or “energy storage mode”, given the extracted air is being supplied to the compressed air store of the ACAES system. Similarly, the “injection mode”, in which air passing successively downstream through the compressor, combustor and turbine, respectively, of the GT system, is supplemented by the injection, at the one or more fluid connections, of pressurised air that is returning from the compressed air store of the ACAES system, may alternatively be referred to as a “discharge mode” or “energy retrieval mode”.

In both the above-mentioned bleed and injection modes, both the GT system (and any steam turbine system, if present) and the ACAES system are operating. Usually, both modes will be “power generation” modes, that is, the hybrid CTPGS will be generating power; however, if the apparatus is suitably configured, for example, with appropriate settings for the mass flow rate into the GT, and selected bleed mass flow rate to the ACAES, and with suitable power ratio's for the selected power machinery, and with a suitably high (preferably constant) pressure store, then it may be possible for the bleed mode to be either a zero power mode or a negative power mode, that is, a mode in which the overall hybrid CTPGS needs to draw power from the grid, even though the gas turbine (and even any steam turbine) is operational.

The phrase “one or more fluid connections located in the vicinity of the compressor and/or combustor”, is intended to cover locations at or near the compressor outlet, or in the combustor chamber but, in any case, upstream of the combustor inlet, so as to allow partly or fully compressed air to be extracted from the compressor before that air is combusted, and similariy to allow air to be injected at or near the combustor so that the injected air can be subsequently combusted therein. Furthermore it may be beneficial for the performance of the gas turbine or the combustors for the injected or bled air to be taken from multiple locations around the gas turbine. For example a gas turbine with ‘can’ combustors might have an inlet/outlet located at each location. It may also be possible to tap into existing passageways that are used for bleeding cooling air to also use them for a dual purpose.

Usually, in the injection mode, air leaving the direct TES is returned to the one or more fluid connections via a (e.g. parallel) flow pathway that bypasses the top-up compressor. However, exceptionally, the air might be further compressed in that machine, or even re-expanded (if a reversible machine), upon its return, for example, over a small selected ratio so that the air re-enters the GT at a suitable temperature or pressure. An example might be where a very high pressure ratio aero-derivative gas turbine (pressure ratio in excess of 30:1) is used as top-up compressor to compress air from 12 bar at minimum load to 20 bar and 450° C. to store in the first TES. Upon exit from this TES during discharge (still at 20 bar) the air is further compressed to 30 bar and 550° C. before injection into the gas turbine. This may be preferable to designing the first TES to be able to withstand the full 30+ bar pressure.

Conveniently, air leaving the direct TES in the injection mode is returned directly to the one or more fluid connections. The direct TES may return sufficiently high quality heat to the returning air that it can be injected directly in to the GT, for example, without needing to pass through any devices that alter (i.e. raise) its temperature (e.g. a heater, or other heat transfer device such as a heat exchanger) or alter (i.e. raise) both its temperature and pressure (e.g. compressor).

The power machinery is usually used asymmetrically in the ACAES between bleed and injection modes such that, in the bleed mode, extracted air is compressed in the top-up compressor and in the second and any subsequent stage power machinery disposed between the direct TES and the compressed air store, but in the injection mode, returning air is only expanded in the ACAES in (second and any subsequent stage) power machinery disposed between the compressed air store and the direct TES (and not expanded elsewhere in the ACAES). The asymmetric use of power machinery between the bleed and injection modes (i.e. pre-compressor only in bleed mode in flow passageway upstream of direct TES) also minimises the amount of power machinery required and the amount of compressed air storage required for a given amount of turn-down.

The compression ratio of the (e.g. variable pressure ratio) top-up compressor may be selected so that the direct TES receives air of a selected pressure and temperature in the bleed mode. This stored higher temperature heat can then be returned to the air in the injection mode, so that air at a desired (slightly lower temperature due to inherent irreversibilities in the heat transfer to/from the thermal store) temperature is injected into the pre-combustor region. However, the pressure of the air returning through the store during the injection mode may be controlled independently by the extent to which the second stage power machinery re-expands it upon leaving the compressed air store: hence, it may be returned to the store at the same or altered (e.g. raised) pressure.

In one embodiment, during the bleed mode, the top-up compressor raises the air pressure in the direct TES to a selected (roughly constant) pressure and, in the injection mode, the second and any subsequent stage power machinery disposed between the direct TES and the compressed air store expand the air so that it returns to the direct TES at substantially the same selected pressure. Hence, the operating pressure in the direct TES stays substantially the same (e.g. within 2 bar) between modes, which has the advantage of designing the pressure casing of the direct TES for similar pressures for both charge and discharge. In that case, that pressure may be selected to be within 0.5-1 bar (e.g. 0.5-1 bar higher) of the GT pre-combustor pressure in the injection mode, and air leaving the direct TES to return to the one or more fluid connections will not normally pass through any compression or expansion stages that would alter that pressure.

In order to keep the store pressure substantially constant, the second and any subsequent stage power machinery may act to compress and expand the air over the same overall ratio in the respective bleed and injection modes, depending on the respective pressures in the direct TES and compressed air store.

This may involve the same constant overall ratio during charge and discharge. However, the compressed air store may be a variable pressure store such that the compression ratio in the second and any subsequent stage power machinery needs to increase over time (i.e. with charge) during the bleed mode, while the expansion ratio correspondingly needs to decrease over time (i.e. with discharge) during the injection mode. In that case, the second and any subsequent stage power machinery may compress and expand over the same ratio for the corresponding extent of charge/discharge of the compressed air store.

A single reversible device may be used. Alternatively, the second (and each subsequent) stage power machinery may include two separate devices they may be evenly sized although it is likely that the charging machinery for bleed may be much larger than that for air injection. The reason for this is that the amount of air that can be injected is limited to around 10% additional mass flow (varies depending upon type of GT) with IGV's open, however bleed rates of 20%, 30% or even 40% of mass flow rate with IGV's open are possible if suitable ductwork is added to the gas turbine.(Note these bleed rates are likely to correspond to a high proportion of the actual flow at the time the bleed occurs as the IGV's are not likely to be fully open. However, using the IGV open condition (normally at ISO conditions) allows for a base line for mass flow from which these percentages can be calculated.)

In view of an inevitable pressure loss across the TES, where the pressure in the direct TES is intended to be kept roughly constant between bleed and injection modes, then the pressure ratio in the bleed mode may be selected, for example, so as to raise the air pressure and hence operating pressure in the direct TES in the bleed mode by 0.5-1 bar in excess of the likely anticipated first compressor air outlet pressure (in the injection mode).

In one embodiment, the pressure ratio of the top-up compressor in the bleed mode is selected such that heat is stored in the direct TES (and hence, is subsequently returned, in the injection mode, to air passing back through the direct TES such that the air returns to the one or more fluid connections of the gas turbine also roughly) at a temperature within 40° C. or less, or 30° C. or less, or 20° C. or less of the first compress or air outlet temperature in the injection mode. In this way, air returning through the one or more fluid connections from storage may closely match the existing air conditions between the compressor and turbine, minimising any irreversible thermal mixing. It therefore avoids the need for additional heat input (e.g. fuel) in the injection power generation mode (likely to be at a maximum load scenario.)

Preferably, the air will return at a close temperature to, but a temperature in excess of, the first compressor air outlet temperature in the injection mode. In one embodiment, the pressure ratio of the top-up compressor in the bleed mode is selected such that heat is stored in the direct TES (and hence, is subsequently returned, in the injection mode, to air passing back through the direct TES such that the air returns to the one or more fluid connections of the gas turbine also roughly) at a temperature of 50° C. or more, or even 80° C. or more, of the first compressor air outlet temperature in the injection mode. Thus, air may then be returned to the gas turbine in the injection mode at a higher temperature than the air emerging from the first compressor air outlet, leading to an averaged increase in temperature which results in improved gas turbine efficiency (e.g. less fuel required by the combustor to achieve the desired combustion conditions). In this case, where a higher pressure ratio is selected for the top-up compressor in the bleed mode, it performs more compressor work. If bleed mode is occurring when at or near minimal load, then a higher pressure ratio for the top-up compressor may further extend the GT turn-down capability as the top-up compressor will require more power. Moreover, since this work is stored as thermal energy, it can be returned highly efficiently in a direct TES, and especially where a layered direct TES is used, thereby assisting with round-trip efficiency.

There will be an upper limit on that compression ratio in that the air can only be compressed up to the direct TES's maximum operating pressure and maximum operating temperature (since the gas is flowing through the solid gas permeable media in direct contact therewith. Both the thermal store and the materials of the top-up compressor are limiting factors, normally being capable of withstanding temperatures up to 620° C.

A higher top-up compression ratio also means that downstream the second and any subsequent stage power machinery process air at a higher initial pressure such that for a fixed size (and cost) of power machinery, a much higher final pressure in the compressed air store may be achieved leading to improved storage density and the possibility of using a smaller volume compressed air store.

In one embodiment, the second and any subsequent stage power machinery disposed between the direct TES and the compressed air store operates with a greater overall pressure ratio upon expansion in the injection mode than the overall pressure ratio upon compression in the bleed mode, such that the direct TES operates at a lower operating pressure during the injection mode than in the bleed mode. In this way, the amount of expansion work is increased (in the second and any subsequent stage power machinery) and hence the turn-up capability of the gas turbine may be extended (e.g. where the injection mode is operating at or close to maximum load e.g. with inlet guide vanes fully open).

Assuming a heat exchanger is located immediately downstream of the first direct TES in the bleed mode, as is customary practice, then this asymmetric (greater) expansion may reduce the amount of waste heat that is discarded at the heat exchanger during the injection mode, meaning that overall less waste heat is lost from the system than with evenly matched second (and subsequent) stage compression and expansion modes. To explain in more detail, irreversibilities in the second stage power machinery between the direct TES and the compressed air store tends to manifest itself in an increased temperature of the air as it re-enters the direct TES during the injection mode. In order to prevent the TES seeing successively increasing inlet temperatures with each charge/discharge cycle, it is well known to place a heat exchanger (e.g. to ambient) on the compressed air store side of the TES. Waste heat discarded at this point is irreversibly lost and hence it is desirable to adjust the second (and any subsequent) stage power machinery so that it expands the air down to a lower temperature, such that less waste heat is discarded from the system overall.

Preferably, the selected expansion ratio expands the air to a pressure that is more than the first compressor air outlet pressure in the injection mode, ideally at least 0.5 bar, or even at least one bar more than that pressure.

The second stage (and any subsequent stage, for example, a final third stage) power machinery may include a separate expander (e.g. turbine) and compressor (e.g. axial flow or turbo-compressor) disposed in alternative parallel pathways in the flow passageway network. Axial flow or turbo-compressors are well suited to handling high mass flow rates.

Alternatively, a single reversible machine may be used. Such reversible power machinery may be positive displacement (e.g. piston based) machinery; the latter is more suited to operation over a variable pressure ratio or where the function of the machinery changes i.e. between charge and discharge cycles.

At the second stage, a pressure reducing device such as a throttle valve may be provided in an alternative flow pathway to a pathway including any second stage power machinery (e.g. a reversible compressor/expander or separate respective machines) and associated heat store) to allow rapid re-expansion of air emerging from storage via that alternative pathway; although the energy of re-expansion is lost in such apparatus, this may be acceptable for a short period of boost running.

The apparatus may be configured to allow air from the compressed air store to be discharged in parallel down both pathways, for example, for a short period of time.

If the system is a low-cost system that does not include any second thermal energy store, the second stage machinery may merely include a second stage compressor for use in the bleed mode, and a pressure reducing device such as a throttle valve located in connection structure forming an alternative flow pathway to the compressor for use in the injection mode; such a compressor may be intercooled and provided with a downstream aftercooler/heat exchanger to provide any necessary cooling of the air before storage.

Preferably, the at least one direct TES includes a direct thermal transfer, sensible heat store including a gas permeable, solid thermal storage medium disposed in respective, downstream, individually access controlled layers.

In one embodiment, the compressed air store includes a constant pressure, compressed air store. The compressed air store may store air at a constant pressure or at a variable pressure. In the former case, power machinery may conveniently operate over fixed power ratio's; moreover, constant power output is thereby achievable with significant economic advantages to the power plant operator (who can for example maximise turn-down capability over selected periods). In the case of variable pressure storage, the power machinery (e.g. the final stage which may be the second stage machinery or a later stage) will need to operate over a variable pressure ratio.

Usually, the compressed air store will include a cavern or one or more high pressure steel pipelines. A constant pressure store can be achieved by using means such as water balancing of the store by means of a suitably high water column. This method is well known in the art.

Commonly, the CTPGS is coupled downstream to a steam turbine plant to form a Combined Cycle Gas Turbine (CCGT) plant. Variable turn-up &down capability, as conferred by the use of the top-up compressor, is of more value in a CCGT plant as the latter will need to avoid switching on and off wherever possible (e.g. heat exchange tubes in steam turbine plant, need time to heat up, etc). Open cycle gas turbine plant (OCGT) plants, especially ones based on aero-derivative GT's, by contrast, tend to be more flexible and capable of switching on and off more easily (e.g. having regard to grid prices or load requirements), so that such a capability is less important.

Usually, the hybrid CTPGS is also operable in a normal power generation mode in which air passes respectively downstream through the compressor, combustor and turbine of the GT system to generate power, but the air flow is not partially supplemented by injection or extracted at the one or more fluid connections.

In the bleed mode, the inlet guide vanes are usually at least partly open, so as to maximise the first compressor inlet mass flow rate.

In the bleed mode, the bleed mass flow rate may be at least two times (preferably at least three times, or at least four times) the maximum injection mass flow rate that is achievable in the hybrid CTPGS. The bleed mass flow rate can be selectively varied (e.g. by adjustment of valving in the flow passageway) more flexibly than the injection rate, being increased to increase compressor work in the ACAES.

In one embodiment, the apparatus is configured so that, when the hybrid CTPGS is operating in the bleed mode, the total output power of all the power machinery in the hybrid CTPGS, and any steam turbine plant that is coupled downstream to it, is either zero or negative, usually negative (so that power is not being generated in the bleed mode).

A hybrid CTPGS with a top-up compressor may allow the turn-down capability of an operating gas turbine (i.e. one with a coupled compressor and expander both operating and with the combustor fired and operating) to be extended to such an extent that zero or negative power (i.e. overall power is being drawn from the grid) is achieved in the bleed mode. The system needs to be suitably configured in the bleed mode, for example, so that the IGV settings (e.g. partly open) are selected to provide a suitable GT inlet mass flow rate, a suitable bleed mass flow rate is selected (e.g. using variable valves), suitable pressure ratio's are selected for the respective (appropriately sized) power machinery and any TES and compressed air stores are designed to meet the (more demanding) selected pressure and temperature conditions.

A zero or negative power mode may be achieved in the bleed mode where the bleed mass flow rate is selected such that the mass flow rate through the gas turbine downstream of the one or more fluid connections is lower than that achievable when the inlet guide vanes are closed (i.e. minimum load condition) and no bleed or injection is occurring in the gas turbine. Also, the pressure ratio across the first (i.e. GT) compressor may be at least 10% lower (preferably at least 15% lower, or even at least 20% lower) than the normal minimum pressure ratio that is achievable across it when the inlet guide vanes are closed (i.e. minimum load condition) and no bleed or injection is occurring. It is easier to achieve zero or negative power in the bleed mode where the compressed air store includes a constant pressure, compressed air store (such that the power machinery can operate over a fixed maximum pressure ratio to compress to the CAES store throughout the whole charge cycle). Further, a zero or negative power mode may be achieved in the case where a steam turbine plant is coupled downstream of the hybrid CTPGS.

Where the power output in the bleed mode becomes negative, the overall system needs to draw power from the grid to operate the three respective (GT, ST, ACAES) sub-systems. The change from positive to negative power in the bleed mode is merely an incremental change for the individual power machines, which may continue to operate in the same way. However, it can have the economic advantage that part of the power plant fuel is now being supplemented in the form of low cost electricity. As the wholesale cost of electricity is likely to be below the marginal cost of production (or there would be no reason to turn down) this should lead to a slight reduction in the cost of the fuel required to operate the power plant as the low cost electricity is being ‘blended’ with the gas fuel input.

Zero power is a condition where all the combined gas turbine, steam turbine and ACAES power machinery outputs are equally balanced. In certain markets it may be simpler to operate in the zero power mode (rather than negative power) as it avoids the complication of having to purchase wholesale electricity.

In the first aspect, there is further provided a method of operating a hybrid combustion turbine power generation system (CTPGS), wherein the hybrid CTPGS includes:

a combustion turbine (GT) system including a first compressor, a combustor and a turbine fluidly connected downstream of each other, wherein the turbine and compressor are coupled on a drive shaft and operatively associated with a generator or motor/generator,

and an adiabatic compressed air energy storage system (ACAES) integrated therewith via one or more fluid connections disposed between the compressor and turbine, so as to allow air to be extracted from, and injected into, the GT system;

wherein the ACAES includes a flow passageway network and associated valve structure leading from the one or more fluid connections to a compressed air store via a first direct thermal energy store (TES); and,

wherein a top-up compressor is disposed in the flow passageway network between the one or more fluid connections and the direct TES, and is so fluidly connected that its inlet receives air extracted from the GT system and its outlet sends air at a higher temperature and pressure towards the downstream direct TES;

the method including:

(i) operating the system in a bleed mode including extracting some air via the one or more fluid connections from air passing respectively downstream through the compressor, combustor and turbine of the GT system and supplying the extracted air to the compressed air store of the ACAES system via the direct TES; and,

(ii) operating the system in an injection mode including supplementing air passing respectively downstream through the compressor, combustor and turbine of the GT system by injecting, at the one or more fluid connections, pressurised air that is returning from the compressed air store of the ACAES system via the direct TES.

In the above method, the system may include any one or more of the features of the system described above,

In a preferred first aspect, there is further provided a method of operating a hybrid combustion turbine power generation system (CTPGS), wherein the hybrid CTPGS includes:

a combustion turbine (GT) system including a first compressor (the “GT compressor”), a combustor and a turbine fluidly connected downstream of each other, wherein the turbine is non-detachably coupled to the compressor and is operatively associated with a generator or motor/generator for power generation;

and an adiabatic compressed air energy storage system (ACAES) integrated therewith via one or more fluid connections located in the vicinity of the compressor and/or combustor, so as to allow air to be extracted from, and injected into, the air flowing through the GT system;

wherein the ACAES includes a flow passageway network and associated valve structure leading from the one or more fluid connections to a compressed air store via a first direct thermal transfer, thermal energy store (direct TES);

wherein a top-up compressor is disposed in the flow passageway network between the one or more fluid connections and the direct TES, and is so fluidly connected that its inlet receives air extracted from the GT system and its outlet sends (outlet) air at a higher temperature and pressure (than the inlet air) towards the downstream direct TES,

wherein a second (higher pressure) stage power machinery and an optional second thermal energy store (TES) are arranged successively downstream of one another in the flow passageway network between the direct TES and the compressed air store: and,

the method including operating the hybrid CTPGS in each of the following modes:

(i) a bleed mode (i.e. charge mode) in which some air is extracted via the one or more fluid connections from air passing respectively downstream through the compressor, combustor and turbine of the GT system as it operates, and the extracted air is supplied to the compressed air store of the ACAES system via the direct TES; and,

(ii) an injection mode (i.e. discharge mode) in which air passing respectively downstream through the compressor, combustor and turbine of the GT system as it operates is supplemented by injecting, at the one or more fluid connections, pressurised air that is returning from the compressed air store of the ACAES system via the direct TES.

Preferably, during the bleed mode, the first compressor air outlet temperature is at least 30° C., or at least 50° C., or even at least 70° C. lower than it is during the injection mode. The incorporation of a top-up compressor upstream of the direct TES is likely to be of particular benefit under these GT conditions, i.e. where the bleed mode is being used when power generation is at or near minimal load and the lower mass flow rate through the turbine has resulted in a significant drop in operating temperature and pressure of the GT at the first compressor air outlet, more generally, in the pre-combustor region (i.e. between the first compressor and turbine). Alternatively expressed, a top-up compressor is likely to be of value where the GT operating pressure in that region is at least 2 bar, or at least 4 bar, or even 5 bar lower in the bleed mode than it is in the injection mode.

In an alternative first aspect, there is provided a hybrid combustion turbine power generation system (CTPGS) including:

a combustion turbine (GT) system including a compressor, a combustor and a turbine fluidly connected downstream of each other, wherein the turbine and compressor are coupled on a drive shaft and operatively associated with a generator or motor/generator,

and an adiabatic compressed air energy storage system (ACAES) integrated therewith via one or more fluid connections disposed between the compressor and turbine, so as to allow air to be extracted from, and injected into, the GT system;

wherein the ACAES includes a flow passageway network and associated valve structure leading from the one or more fluid connections to a compressed air store via a first direct thermal energy store (TES); and,

wherein a top-up compressor is disposed in the fluid passageway network between the one or more fluid connections and the direct TES, and is so fluidly connected that its inlet receives air extracted from the GT system and its outlet sends (outlet) air at a higher temperature and pressure (than the inlet air) towards the downstream direct TES.

Second Aspect

In a second aspect, there is provided a hybrid combustion turbine power generation system (CTPGS) including:

a combustion turbine (GT) system including a compressor, a combustor and a turbine fluidly connected downstream of each other, wherein the turbine is non-detachably coupled to the compressor and is operatively associated with a generator or motor/generator for power generation,

and an adiabatic compressed air energy storage system (ACAES) integrated therewith via one or more fluid connections disposed between the compressor and turbine, so as to allow air to be extracted from, and injected into, the GT system;

wherein the ACAES includes a flow passageway network and associated valve structure leading from the one or more fluid connections to a compressed air store via a first direct thermal energy store (TES);

wherein a second (higher pressure) stage power machinery and an optional second thermal energy store (TES) are arranged successively downstream of one another in the flow passageway network between the direct TES and the compressed air store; and,

wherein a top-up compressor is disposed in the fluid passageway network between the one or more fluid connections and the direct TES, and is so fluidly connected that, in a bleed mode, its inlet receives air extracted from the GT system and its outlet sends (outlet) air at a higher temperature and pressure (than the inlet air) towards the downstream direct TES,

wherein the hybrid CTPGS is configured to operate in a bleed mode (i.e. charge mode) in which some air is extracted via the one or more fluid connections from air passing respectively downstream through the compressor, combustor and turbine of the GT system, the extracted air being supplied to the compressed air store of the ACAES system via the direct TES, and, the total output power of all the power machinery in the hybrid CTPGS, and any steam turbine plant that is coupled downstream to it, is either zero or negative (so that power is not being generated in the bleed mode).

The above second aspects may include any additional features mentioned in the first aspect for the zero or negative power embodiments. In particular (i) the total output power may be negative, (ii) a steam turbine plant may be coupled downstream of the hybrid CTPGS, (iii) the compressed air store may include a constant pressure, compressed air store, (iv) in the bleed mode, the mass flow rate through the gas turbine downstream of the one or more fluid connections may be lower than that achievable when the inlet guide vanes are closed (i.e. minimum load condition) and no bleed or injection is occurring in the gas turbine, and (v) in the bleed mode, the pressure ratio across the first (i.e. GT) compressor may be at least 10% lower (preferably at least 15%, or even at least 20% lower) than the normal minimum pressure ratio that is achievable across it when the inlet guide vanes are closed (i.e. minimum load condition while meeting emission standards) and no bleed or injection is occurring. In addition, the inlet guide vanes will usually be partly open.

According to the second aspect, there is further provided a method of operating a hybrid combustion turbine power generation system (CTPGS) in a bleed mode, wherein the system includes:

a combustion turbine (GT) system including a compressor, a combustor and a turbine fluidly connected downstream of each other, wherein the turbine is non-detachably coupled to the compressor and is operatively associated with a generator or motor/generator for power generation,

and an adiabatic compressed air energy storage system (ACAES) integrated therewith via one or more fluid connections disposed between the compressor and turbine, so as to allow air to be extracted from, and injected into, the GT system;

wherein the ACAES includes a flow passageway network and associated valve structure leading from the one or more fluid connections to a compressed air store via a first direct thermal energy store (TES);

wherein a second stage power machinery and an optional second thermal energy store are arranged successively downstream of one another in the flow passageway network between the direct TES and the compressed air store; and,

wherein a top-up compressor is disposed in the fluid passageway network between the one or more fluid connections and the direct TES, and is so fluidly connected that, in a bleed mode, its inlet receives air extracted from the GT system and its outlet sends air at a higher temperature and pressure towards the downstream direct TES; and,

wherein the bleed mode includes:

passing air respectively downstream through the compressor, combustor and turbine of the GT system;

extracting some of that air via the one or more fluid connections;

supplying the extracted air to the compressed air store of the ACAES system via the direct TES; and,

configuring the hybrid CTPGS such that the total output power of all the power machinery in the hybrid CTPGS, and any steam turbine plant that is coupled downstream to it, is either zero or negative.

In an alternative second aspect, there is provided a hybrid combustion turbine power generation system (CTPGS) including:

(i) a combustion turbine (GT) system including a compressor, a combustor and a turbine fluidly connected downstream of each other, wherein the turbine is non-detachably coupled to the compressor, and (ii) an adiabatic compressed air energy storage system (ACAES) integrated therewith, wherein the CTPGS is operable in a bleed mode in which air is extracted (bled) from the GT system into the ACAES and the total output power of all the power machinery in the hybrid CTPGS, and any steam turbine plant that is coupled downstream to it, is either zero or negative (so that power is not being generated in the bleed mode).

### BRIEF DESCRIPTION OF THE FIGURES

Some embodiments will now be described, by way of example only, with reference to the accompanying drawings in which:

FIG. 1 is a schematic diagram of a conventional combined cycle gas turbine (CCGT) system of the related art;

FIG. 2a shows a first embodiment operating in an air bleed (or charge) mode;

FIG. 2b shows the first embodiment operating in an air injection (or discharge) mode;

FIG. 3a shows a second embodiment operating in an air bleed mode;

FIG. 3b shows the second embodiment operating in an air injection mode;

FIG. 4 shows a third embodiment operating in an air bleed mode with operating conditions indicated for a zero power bleed mode; and,

FIG. 5 shows a fourth embodiment operating in an air bleed mode with operating conditions indicated for a negative power bleed mode;

FIG. 6 shows a fifth embodiment with reversible second stage power machinery;

FIG. 7a shows a sixth embodiment that does not have a second TES;

FIG. 7b is a graph showing intercooler compressor power against time over a recharge period; and,

FIGS. 8a to 8c respectively show a seventh embodiment, including a charging compressor upstream of the top-up compressor, operating in various respective modes.

### DETAILED DESCRIPTION OF THE EMBODIMENTS

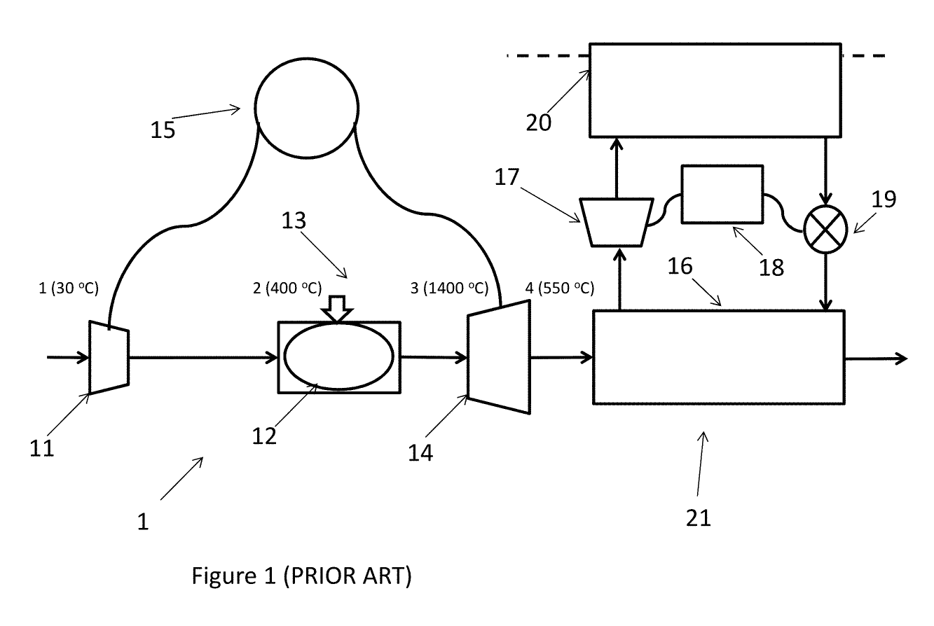

FIG. 1

FIG. 1 shows a typical layout of a related art combined cycle gas turbine (CCGT) 1 used for peaking power generation, with an upstream compressor 11 directly coupled to a downstream turbine (expander) 14 and driving a generator 15 (e.g. connected to a transformer/grid). Between compressor 11 and turbine 14 is a combustion chamber 12 supplied with natural gas 13. In a normal configuration the compressor, turbine and generator are all directly coupled on the same shaft by drive couplings (not shown). Filtered air enters the compressor at ambient conditions (e.g. 30° C., 1 bar) and is compressed up to a higher pressure and temperature (e.g. 400° C., 16 bar). The hot high pressure air enters the combustion chamber where it is mixed with natural gas and caused to combust, heating the gas to a much higher temperature (e.g. 1400° C., 16 bar). This air is then expanded back to atmospheric pressure in the turbine, which produces more power than the compressor absorbs, hence there is a net generation of power that can drive the generator 15.

In the case of an open cycle gas turbine (OCGT), the cooled air is exhausted from the turbine well above ambient temperature (e.g. 450° C., 1 bar). However, in the case of a CCGT, the turbine operates with an exhaust temperature that is slightly hotter, either by operating at a lower pressure ratio or by combusting to a higher turbine inlet temperature. After the exhaust from the turbine 14, the hot high temperature exhaust gas (e.g. at 550° C., 1 bar) enters a heat exchanger 16, where it is cooled while heating a counter-flow of water that is at high pressure. The water normally becomes superheated during the heat exchange process and is then expanded through steam turbine 17 to a lower pressure. This steam is then condensed in condenser 20 before being pumped back to a high pressure by water pump 19 to return to the heat exchanger 16. The condenser 20 is normally supplied with a cooling water flow from a river or the sea. Steam turbine 17 is normally directly coupled to water pump 19 by generator 18 and the expansion of the steam in the steam turbine 17 produces more power than the water pump 19 absorbs, resulting in a supplementary net production of power. Due to the large thermal mass of different components, a CCGT needs to avoid switching on and off wherever possible, and hence, any features conferring variable turn-up &down capability are of particular value to such plants.

The remaining figures show some embodiments. All embodiments relate to a conventional combustion turbine arrangement in which the compressor, combustor and turbine are permanently fluidly connected downstream of each other, so that whenever the gas turbine is operating at least some air flow passes successively downstream through all those components in turn, regardless of whether or not a portion of the flow is being extracted or augmented at the one or more fluid connections, and in that the turbine is non-detachably coupled to the compressor so that both operate together when power is being generated by the turbine.

Further, all embodiments are shown as part of a combined cycle gas turbine system (CCGT), but they could be any other suitable derivative combustion turbine plant, or could be merely a simple cycle gas turbine (OCGT) system.

According to some embodiments, an additional compressor is provided upstream of the direct thermal energy store (TES) so that air extracted from the gas turbine in a bleed mode is subjected to a top-up (adiabatic or near adiabatic) compression stage prior to entering the direct TES, thus entering it at a higher temperature and pressure.

In the case of a hybrid combustion turbine power generation system with an integrated ACAES system and a non-decouplable gas turbine, air bleed and air injection usually takes place at or near minimum load and maximum load, respectively, when generating power.

To explain, gas turbines are often used in only two generating modes. The first is full power, where the price of electricity in the wholesale market is above the marginal cost of production, and hence the operator of the plant wants to maximise the sale of electricity at that point. The second is minimum load, which is where the cost of electricity is below the marginal cost of production, but where the losses may be less than the cost associated with stopping and restarting the gas turbine. The minimum load is normally determined by a requirement that CO emissions do not go above a certain level (associated with a low combustion temperature) and, for most gas power plant the minimum load is around 40-50% of the maximum load. Minimum load is normally achieved with the Inlet Guide Vanes (IGV's) closed. Maximum power is normally achieved with the IGV's open. Ambient temperature also has a significant impact on the maximum power that can be achieved and, on a warm day, this is likely to be well below the maximum power rating of the power plant. The maximum power rating is normally only achieved on very cold days.

A problem for a hybrid CTPGS with integrated ACAES including a direct TES downstream of the GT is that the GT compressor (first compressor) exit conditions (pressure and temperature) are likely to vary between air bleed (e.g. charge to further reduce minimum load) and air injection (e.g. discharge to increase peak power). During normal maximum power operation, the compressor exit conditions might be 450° C. and 18 Ba r. During maximum bleed operation, however, the pressure and temperature can drop much lower to e.g. 380° C. and 12 bar. If inlet guide vanes are used (closed) in conjunction with an air bleed, the temperatures and pressures can drop even further. There are two problems associated with bleeding at this temperature and pressure.

The first is that the direct TES (thermal store) is then not being charged at the ideal correct temperature for feeding back into the gas turbine (e.g. 450° C.). During discharge, thermal mixing would occur (irreversible mixing) between the gas flow from the store (e.g. 380° C.) and the gas flow from the GT compressor (e.g. 450° C.). More fue I would then be required to achieve the same turbine inlet temperature (reducing GT efficiency), changing the air fuel ratio (possibly resulting in a sub-optimal air/fuel ratio and an increase in GT emissions). If more fuel is required per kg of air, the efficiency of the gas turbine will reduce resulting in an increase in the GT heat rate. Some of the benefits are therefore lost from storing the compressed air, resulting in a reduction in the round trip efficiency of the compressed air storage system.

The second is that the compression ratio in the second stage compressor (after the direct TES) will be higher resulting in a high temperature post compression. During the discharge process this expansion ratio is likely to be lower than the charging compression ratio, because on discharge the GT is operating at a higher pressure ratio. Consequently there will be an associated increased temperature after the expansion in the second stage turbine that needs to be rejected as waste heat to ambient via heat exchangers i.e. some heat cannot be usefully converted back into power resulting in a lower efficiency. This will result in the work of compression of the second stage compressor being significantly higher than the work recovered (for the same mass flow) from the second stage turbine.

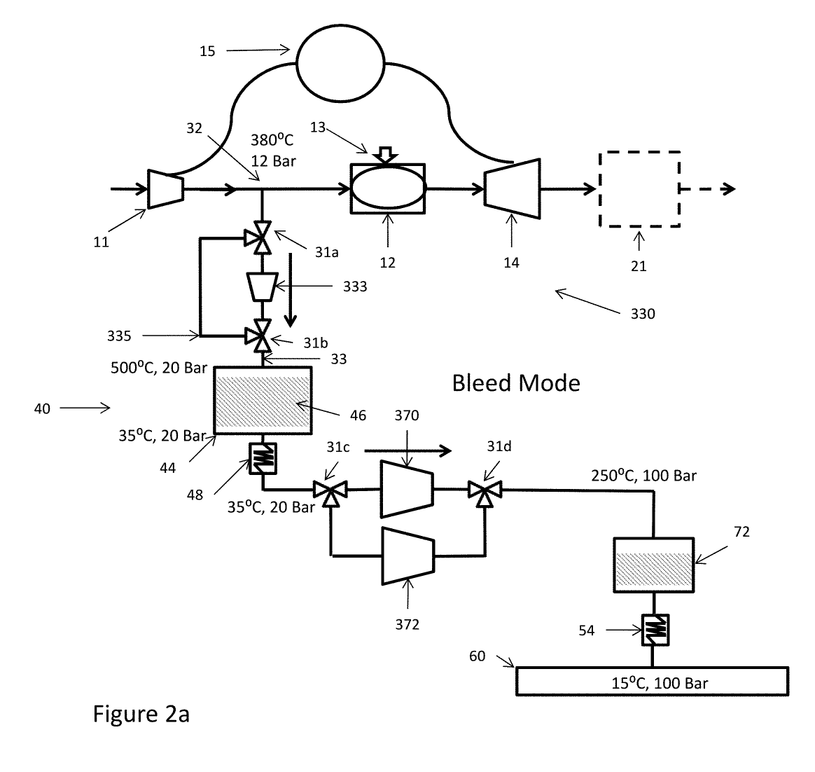

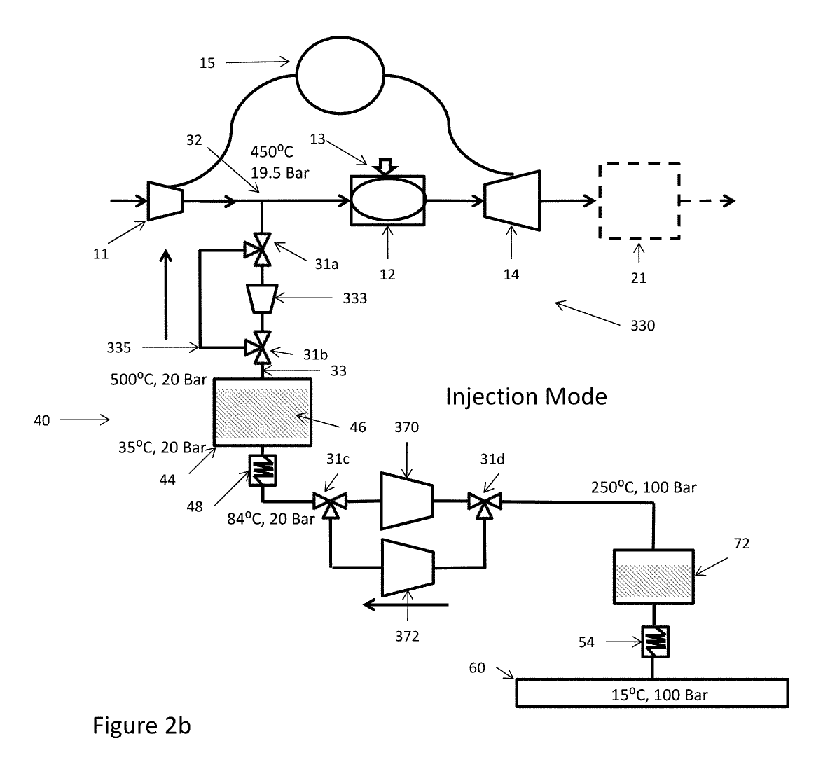

According to some embodiments, it is possible at least partially to alleviate these issues by the provision of a top-up compressor upstream of the direct TES. In this way, the temperature and pressure conditions at the thermal store can be controlled to be optimal for injection back into the GT combustor. The thermal store exit temperature and pressure can then, for instance, be selected closely to match that of the GT compressor exit during injection mode, resulting in minimal thermal mixing and optimum injection flow. The thermal store can also run at a constant pressure, if desired, rather than seeing a different pressure on charge versus discharge. These are exemplified in the embodiments of FIGS. 2a and 2b below.

Additionally, the power required from the top-up compressor can significantly increase the turn-down (reduction in output power) during storage/air bleeding. This increases the flexibility of the GT plant (power range over which the GT plant can operate). An alternative way of viewing this benefit is that, for the same bleed rate (kg/s), the GT output power can be reduced further than would originally have been possible with compressors after the direct TES. The reason for this increased power requirement is that the energy required to compress a kg of gas over a fixed pressure ratio increases if the starting temperature is higher. As an example, to compress 1 kg/s of air from 12 bar 380° C. to 20 bar 500° C. will require 122 kW of shaft power for a centrifugal compressor. To compress the same quantity of air from 12 bar 15° C. to 20 bar would only require 54 kW of shaft power.

A further benefit is that use of the top-up compressor means that the second stage compressor is compressing air that starts at a higher initial pressure (but usually cooled back to ambient). Hence, for a selected peak pressure ratio in the second stage machinery a higher final pressure will be achieved in the compressed air store (leading to improved storage density and the possibility of using a smaller volume compressed air store) and the efficiency of the storage process will be higher as the power per unit mass flow required to compress on charge and expand on discharge will be closer i.e. there will be lower losses.

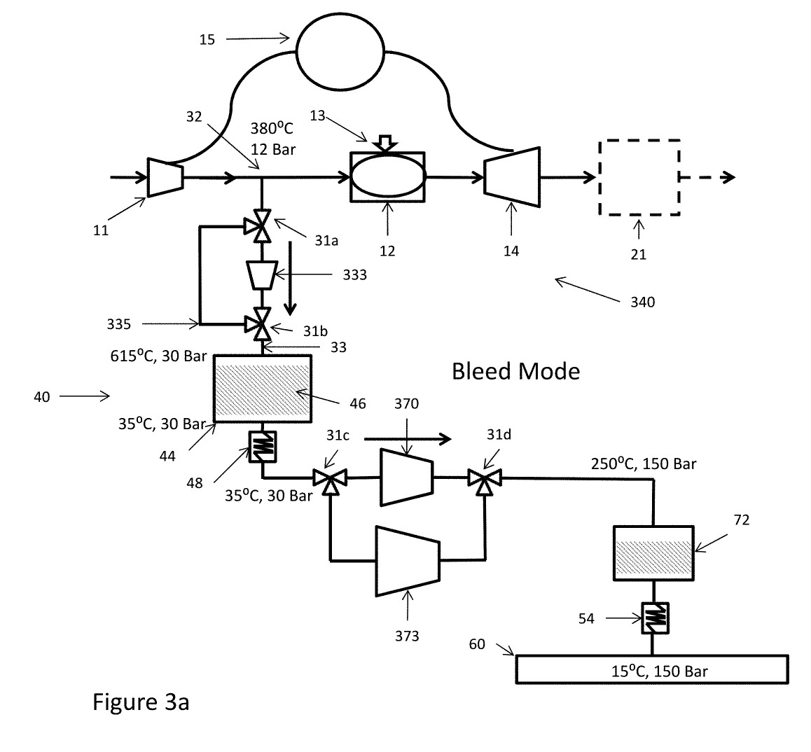

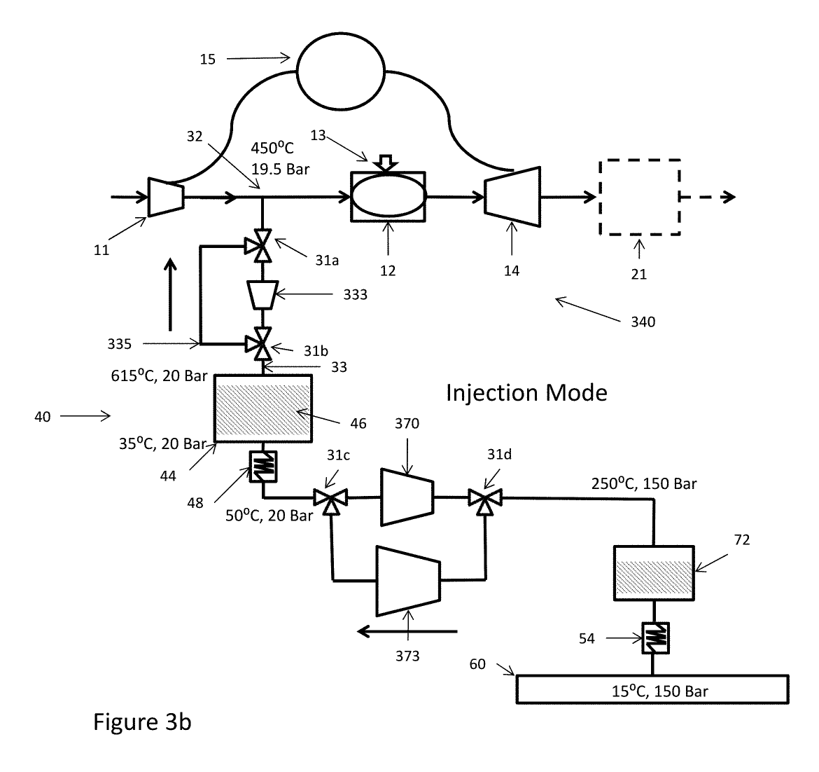

It is also possible to charge the thermal store at a higher temperature (and pressure) than say 450° C. (and 18 bar) in bleed mode. This is exem plified in the embodiments of FIGS. 3a and 3b below. This will not only increase the turn-down capability further (power required for additional pre-store compressor increases by a factor of three if the first stage thermal store is at 615° C.), but the GT efficiency will increase slightly upon discharge (the amount of fuel required to heat the air to a certain turbine inlet temperature is reduced). It will raise the peak pressure that can be reached for a given pressure ratio in the second stage compressor. Power output during air injection may also be enhanced if, as exemplified in those figures, the overall expansion ratio of the second and any subsequent stage power machinery is selectively increased (beyond the charging compression ratio of that machinery stage) to expand the air back down to a pressure below the store pressure in the bleed mode, i.e. closer to the (lower) operating pressure in the gas turbine in the injection mode.

FIGS. 2a and 2b

Referring now to FIGS. 2a and 2b, these show a first embodiment.

Hybrid combustion turbine power generation system (CTPGS) 330 includes a conventional GT arrangement with an upstream compressor 11 directly (and non-detachably) coupled to a downstream turbine (expander) 14, which drives a generator or motor/generator 15 connected for example to a transformer/grid. Between compressor 11 and turbine 14 is a combustion chamber/combustor 12 with a fuel inlet 13.

The CTPGS 330 may be coupled downstream to an optional (shown as dotted lines) steam turbine plant 21 to form part of a combined cycle gas turbine system (CCGT).

An adiabatic compressed air energy storage system (ACAES) is integrated with the GT, usually as a retrofit process. The ACAES is integrated via one or more fluid connections 32 disposed downstream of the compressor and upstream of the turbine, for example, at the compressor outlet, at the turbine inlet or in between those, for example, in the combustor casing. Note it may also be possible for the extraction point to be close to the compressor exit but located in one or more of the later stages of the compressor—a compressor might have 18 stages for example. These allow a fraction of the airflow to be extracted (bled) from, and/or some pressurised air to be injected into the GT system upstream of the turbine, when it is active (with an airflow passing successively down through the compressor, combustor and turbine). The one or more fluid connections 32 may be a single fluid connection or multiple connections, for example, for respective extraction and injection. For example, for a gas turbine with multiple can combustors, they may include individual ports into each combustor casing with a manifold connecting them all to the pressurised air supply.

The ACAES includes a flow passageway network 33 and associated respective downstream valve structure 31a-31d configured to allow selective operation in various modes. Successively downstream of the fluid connection 32, the flow passageway network 33 includes a top-up compressor 333 in a (charge) pathway and an alternative (discharge) bypass pathway 33, these being arranged in parallel between respective selector valves 31a and 31b, at least one direct TES store 40, preferably a heat exchanger 48 (e.g. allowing heat rejection to ambient), second stage (higher pressure) power machinery including a second stage compressor 370 (e.g. axial flow compressor, reciprocating, centrifugal or turbo-compressor to name a few examples) disposed in a charging flow pathway, and a second stage expander 372 (e.g. centrifugal, turbo or axial flow turbine to name a few examples) disposed in an alternative discharging flow pathway, these being arranged in parallel between respective selector valves 31c and 31d, followed by an optional second (direct or indirect) TES 72, and optional heat exchanger 54 (e.g. again allowing heat rejection to ambient), and finally, the compressed air store 60.

The high pressure compressed air storage 60 may be a manufactured pressure vessel such as high pressure pipe or a welded steel vessel or a larger containment means such as an underground gas cavern. In the examples below, the compressed air storage 60 is a constant pressure, compressed air store. This can be achieved by means of using a 1000m column of water to maintain the pressure.

The compressed air store may however be a variable pressure store, in which case the second and any subsequent stage power machinery 370, 372 should be suitable for operation over the varying pressure ratio associated with the operational pressure range of the compressed air store.

The second stage power machinery may instead include one or more single reversible compressor/expander, which may be a positive displacement device, such as a reciprocating piston compressor/expander that is able to vary between compressing and expanding gas by changing of valve timing and it may again be operable over a variable pressure ratio.

The direct TES system may include one or more thermal stores 40 based on direct heat transfer to the thermal storage media. The thermal store 40 may be a direct TES with solid, gas permeable thermal storage media 46 such as crushed rock, concrete or other suitable particulate material, or, more structured gas permeable material such as formed ceramic blocks, held within a thermally insulated vessel 44. The media may thus have a monolithic or packed bed structure and be a layered or unlayered design. In particular, thermal media 46 may include a packed bed of suitable thermal media such as high temperature concrete, ceramic components, refractory materials, natural minerals (crushed rock) or other suitable material.

Thermally insulated vessel 44 must be designed so that the high pressure flow can pass through the vessel transferring heat directly to/from the thermal media 46 at the required charging or discharging rates. As there is direct heat transfer of heat to the media from the compressed gas, the thermally insulated vessel 44 will normally be an internally insulated pressure vessel. Whilst a direct TES does need to be built to withstand the gas pressure, it has the capability to store and return heat very efficiently, particularly if it is a layered store arrangement, and (unlike heat exchangers which require pre-conditioning) it can be switched from a storage (dormant) mode to a charging or discharging mode within seconds, which is important for a quick response hybrid GT system.

Referring to FIG. 2a, the gas turbine 11/12/14 is shown in operation generating power in a bleed (charging) mode, while in FIG. 2b, the gas turbine 11/12/14 is in operation generating power in an injection (discharging) mode.

In this example the thermal store pressure conveniently remains the same between charge and discharge, namely it is controlled to be at about 20 bar during charge and discharge, which is a suitable pressure for discharging back into the GT combustor.

During bleed mode (charge), the IGV's are at least partly open. Compressed air is selectively bled from the one or more fluid connections 32 at 12 bar and passed down passageway 33 such that the remaining mass flow rate through the GT is chosen to be about the same mass flow rate as at normal minimum load (IGV's fully closed). Selector Valves 31a and 31b are set to allow the air to pass through top-up compressor 333 where it is then compressed up to 20 bar. This increases the temperature of the store inlet air close to 500° C. so that heat that is close to this peak temperature can be stored in the direct TES as the air passes through the gas permeable storage media 46 with direct heat transfer thereto. Waste heat is then discarded to ambient as the air passes through heat exchanger 48 so that the air cools to about 35° C. (actual figure dependent upon ambient temperature and type of heat exchanger).

Second stage compressor 370 (e.g. axial flow or turbo-compressor) is then used to compress the air at a 1:5 compression ratio to the maximum allowable temperature for the indirect TES 72, for example, 250° C. and 100 bar, before waste heat is again discarded through heat exchanger 54, resulting in the air being stored in the compressed air store 60 at a constant pressure of about 100 bar is used.(A low cost liquid thermal store using a mineral oil can easily be achieved at 250° C.. If the temperature is higher it is normally necessary to use more expensive synthetic thermal oils, which may also require higher pressure tanks. At 250° C. it is normally possible to use an oil with a very low vapour pressure, which means that the storage tank is unpressurised.)

During the injection mode, the IGV's are fully open. The air returns through the same components to the direct TES 40, except that it passes through turbo-expander 372. This is sized so that it can deliver the correct mass flow to the gas turbine. There is normally a limit on the amount of air that can be injected into a gas turbine before the compressor stalls (surge). (This injection limit is normally much lower than the amount of air that can be bled from the GT.) Turbo-expander 372 is in a parallel pathway, accessed via switching of the settings of selector valves 31c and 31d, and expands the air back across the same ratio (5:1) to the same thermal store pressure of 20 bar, resulting in an air temperature of 84° C. at the entry to the heat exchanger 48 (e.g. when compressed air store is at peak pressure of 100 bar). This increase in temperature is the result of irreversible processes in the turbo-expander. As a result some heat then needs to be rejected via the heat exchanger 48 to reduce the store entry temperature of the air down to 35° C.

The air then passes back in reverse through direct TES 40 before selector valves 31b and 31a direct it along a bypass pathway 335 so that it circumvents the top-up compressor 333. The air is then returned to the one or more fluid connections 32 at about 20 bar, 500° C. and enters the combustor to mix with the 19.5 bar, 450° C. air from the GT compressor 11. In this case it is assumed that there is a 0.5 bar pressure drop between the TES 40 and the gas turbine. With careful design of ducting, corners, junctions and valves it should be possible to minimise this pressure difference. Thus, use of the top-up compressor in the bleed mode has allowed the air to be returned to the GT at a selected temperature and pressure suited (i.e. matched) to the gas turbine operating conditions.

It should be understood that there is likely to be a slight temperature difference (not described in these examples) between the air entering the direct TES on charge and the air exiting the direct TES on discharge. With careful design this temperature difference can be very low. For an indirect TES this temperature difference is likely to be greater as there are a number of losses occurring in the heat transfer process.

In the FIG. 2a embodiment, it was possible to obtain a turn-down (reduction in output power) during storage/air bleeding down to 20% of base load power (i.e. the maximum power with IGV's open and no bleed or injection) with the top-up compressor. By contrast, in apparatus that did not include the top-up compressor, a turn-down during storage/air bleeding could only be achieved to 26% of base load power. Hence, turn-down has been extended by 6%.

In FIGS. 2a and 2b and FIGS. 3a and 3b below, it is possible that all power machinery is directly coupled to a single main shaft operatively coupled to a generator or motor/generator. However, power machinery in the ACAES may be individually coupled to alternative drive shafts and have their own respective motor/generators or all compressors are connected on a single shaft via a clutch to a motor/generator and all turbines/expanders are connected on a single shaft via a clutch to the same motor/generator.

FIGS. 3a and 3b

FIGS. 3a and 3b show a second embodiment. In this embodiment, the operating pressure in the direct TES changes between the bleed and injection modes and the second stage power machinery operates over different pressure ratios between the two modes.

FIGS. 3a and 3b depict the hybrid CTPGS running in a power generation bleed (charge) mode and power generation injection (discharge) mode, respectively. Once again, the CTPGS 330 may be coupled downstream to an optional (shown as dotted lines) steam turbine plant 21 to form a CCGT.

The only difference in system components between FIGS. 3a and 3b and FIGS. 2a and 2b is that in FIGS. 3a and 3b the second stage expander 373 is a larger power machine than the second stage compressor 370 reflecting the fact that it expands the air over a greater pressure ratio. Otherwise, the differences materialise in how the system is operated.

During bleed mode (charge), the IGV's are again at least partly open and the bleed rate is again selected such that the remaining mass flow rate through the GT is chosen to be about the same mass flow rate as at normal minimum load (IGV's fully closed).

In this example, in the bleed mode, the top-up compressor 333 uses a higher ratio such that the air enters the direct TES 40 at 615° C. and 30 bar. This increases the power consumed during the bleed mode and will increase the turn-down capability of the GT. In the FIG. 3a embodiment, it was thus possible to obtain a turn-down (reduction in output power) during storage/air bleeding to 15% of base load power with the top-up compressor.

Once again, the air is cooled to 35° C. in the heat exchanger 48 after leaving the store 40, and is again subjected to a 1:5 compression ratio in the second stage compressor 370. But in this case, that ratio results in air being stored in the air store at an even higher pressure of 150 bar; this may reduce the store cost in that the same mass of air may be stored in a smaller volume.

In the injection mode, the IGV's are fully open. The air returns through the larger second stage expander 373, which operates over a 7.5:1 expansion ratio, expanding the gas down to 20 bar, which is suitable for returning the hot air to the combustor. This increases the power output from expander 373 as compared with previous expander 372, thereby increasing the GT turn-up capability in the injection mode. In this mode, the direct TES store operating pressure is at 20 bar.

Irreversibility from the compression stages during charge and the second stage expansion during discharge at expander 373 results in excess heat within the system that in the FIG. 2a/b embodiment is partially rejected by heat exchanger 48 (air is at 84° C.). By increasing the expansion ratio of expander 373, there is a better thermal match between the exit temperature of expander 373 and the entry temperature at the bottom of the TES 40, in that the expander outlet temperature in this example is only 50° C. (when air store at peak pressure of 150 bar). Hence, less waste heat is being rejected in this embodiment than the previous one.

More heat is retained in the system and is then fed back into the gas turbine combustor. When within the gas turbine, this extra heat can be usefully used to increase the temperature of the working fluid, thus requiring less fuel to reach optimum turbine inlet temperature. This results in an improvement in GT efficiency and a reduction in heat rate.

Possible benefits of this embodiment may be summarised as:
i. Improved GT efficiency from injecting air that is hotter than GT compressor exit temperatures.
ii. Less rejection of waste heat due to compression/expansion process irreversibility.
iii. Higher round-trip efficiency.
iv. Increased turn-down as the power required to drive the top-up compressor is increased.
v. Increased ‘turn-up’ as the power from the second stage expander is increased.
vi. Increased compressed air store pressure for a given second stage compression ratio, so less volume is required to store the same mass of air. This might reduce the cost of the compressed air store in some circumstances.

Although not shown in this embodiment, the temperature and pressure of the direct TES 40 could be increased further resulting in an exact thermal match between expander 373 exit and the TES inlet temperature. This would result in no heat rejection at heat exchanger 48 on discharge. This would, however, require compressors and a thermal store that would work over these temperature ranges. Note that it is difficult to design compressors that can operate much above 600° C. and pressure vessels become very expensive a s the pressure requirement increases.

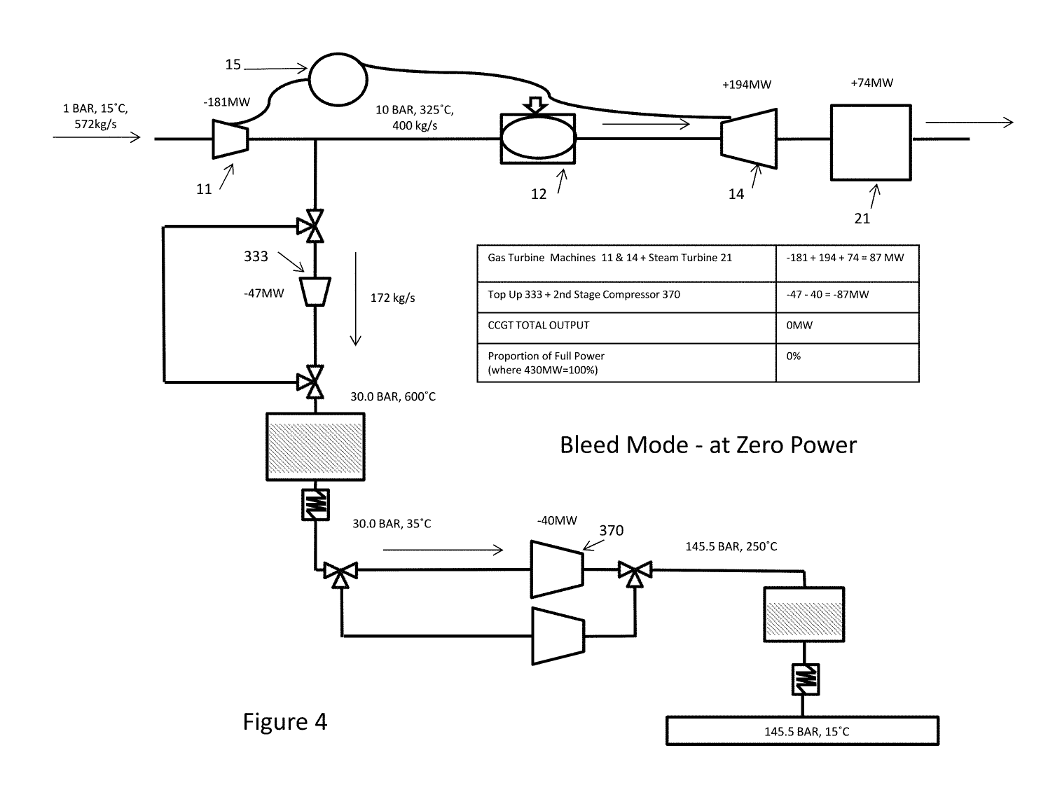

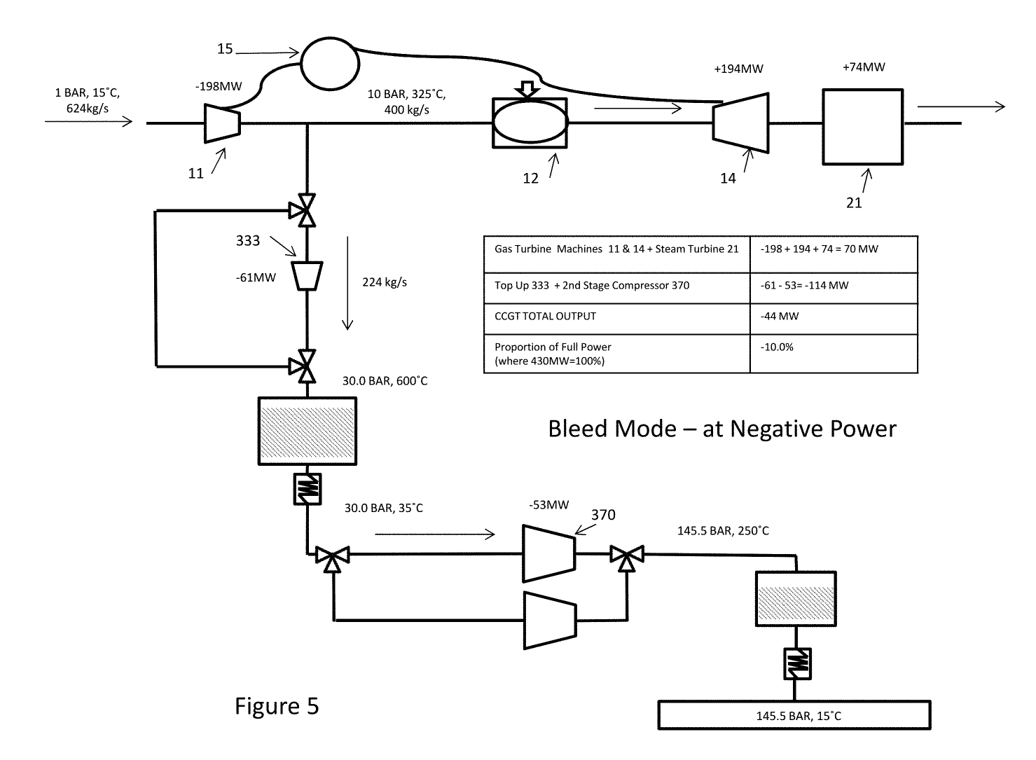

FIGS. 4 and 5

These Figures depict a further embodiment including a hybrid CTPGS of the same arrangement as that of FIGS. 2a-2b, namely, with a steam turbine 21 located downstream of the gas turbine 11/12/14, and at least motor/generator 15 operatively coupled thereto.

FIGS. 4 and 5 respectively illustrate how, in the bleed mode, a hybrid CTPGS with a top-up compressor 333 may be operated in the bleed mode so as further to lower the power output (as compared with FIG. 2a) so as to achieve zero power, or, indeed, to achieve a negative power so as to draw power from the grid, respectively, taking into consideration the summed (total) power figures for (1) the Gas Turbine including gas turbine compressor 11 and gas turbine expander 14, (2) the Steam Turbine including ST plant 21, and (3) the ACAES system including top-up compressor 333 and second stage compressor 370.

In the earlier examples of FIG. 2a,b and FIG. 3a,b, the fluid connections diverted a selected mass flow to storage such that the mass flow rate of the remaining flow through the GT (after the fluid connections) was maintained at roughly the usual minimum load (IGV's closed) mass flow rate.

In FIGS. 4 and 5, in bleed mode the IGV's are again part open. However, in these embodiments, the bleed rate is selected so that the remaining GT mass flow rate is dropped to below the minimum base load flow rate through the GT. As a result, the operating pressure in the GT upstream of the combustor is lower (10 bar) than the lowest operating pressure that can be achieved at minimum load conditions (e.g. usually about 12 bar in this example) in FIG. 2. Because more of the mass flow has been diverted to storage, the respective compressor powers in the ACAES are higher, consuming more power than in FIG. 2. The gas turbine should have a combustor that is designed or adapted for operation at these low flow rates. There is no problem of CO emissions as the combustion temperature can be maintained at a suitable level. However, the lower mass flow rate through the turbine means that for the same turbine inlet temperature that would be used at normal minimum load, the pressure ratio will fall to a level well below that which can be achieved at normal minimum load operating conditions. As has been explained in this example, it might be 9 or 10 bar versus a normal minimum load pressure of 12 bar (25% lower),or it could be as low as 6 bar or less, i.e. a 50% lowering of the normal minimum pressure ratio. This low operating pressure ratio cannot be achieved without some form of bleed as there is only a limited variation in mass flow through the main compressor that can be achieved with IGV's. This variation is fixed between these two conditions. The bleeding of additional air reduces the mass flow through the turbine to below the level which can be achieved with IGV's fully closed.

The lower mass flow rate and lower pressure through the turbine also results in a much lower power output from the turbine section and the steam turbine section. In addition the lower pressure ratio of the main GT also increases the work of the top-up compressor 333 for a target pressure ratio i.e. it is increased per kg of air that is bled from the system. As has been previously explained, the reason for this increased work is that a lower pressure ratio at the gas turbine means that the top-up compressor must operate over a larger pressure ratio (for a target pressure in the first TES), resulting in more work being carried out per kg of air compressed in the top-up section. The air that simply passes through the combustor/turbine section of the GT is not subjected to this additional compression work.

Comparing FIGS. 4 and 5, as mentioned above, both use partly open IGV's. The IGV's are more open in FIG. 5 than FIG. 4 (mass flow rate increases from 572 to 624 kg/s), and the extra air admitted is all diverted down to storage (224 kg/s as opposed to 172 kg/s), thereby raising the top-up and 2nd stage compressor powers in bleed mode, as well as the gas turbine compressor 11 power. Thus, while FIG. 4 achieves zero power, a condition where all the combined gas turbine, steam turbine and ACAES power machinery outputs are equally balanced, in FIG. 5 the power output in the bleed mode actually becomes negative (−44 MW) such that the overall system needs to draw power from the grid to operate the three respective sub-systems. This can have the economic advantage that part of the power plant fuel is now being supplemented in the form of cheap electricity. As the wholesale cost of electricity is likely to be below the marginal cost of production (or there would be no reason to turn down) this should lead to a slight reduction in the cost of the fuel required to operate the power plant as the cheap electricity is being ‘blended’ with the gas fuel input. However, in certain markets it may be simpler to operate in the zero power mode as it avoids the complication of having to purchase wholesale electricity.

In FIGS. 4 and 5, it is possible that all the power machinery in the system is directly coupled to a single main shaft operatively coupled to a generator or motor/generator. However, power machinery in the ACAES may be individually coupled to alternative drive shafts and have their own respective motors or generators or motor/generators.

It should be understood that the use of clutches and synchronous motor/generators means that electrical equipment used for driving compressors during bleeding can also be used to generate electricity from turbine/expanders during injection by clutching and de-clutching suitable machinery.

TABLE 1

| Power Output | | | Mode | IGV's | Embodiment |
|---|---|---|---|---|---|
| +ve | 115% | High - | Injection | Fully | Hybrid CTPGS: FIGS. |
| | | but uses | | open | 2b&3b |
| | | less fuel | | | |
| +ve | 115% | High | Injection | Fully | Comparative Example: |
| | | | | open | Hybrid CTPGS without |
| | | | | | top-up compressor |
| +ve | 100% | Base | None | Fully | Normal Gas Turbine |
| | | Load | | open | |
| +ve | ~40% | Mini- | None | Closed | Normal Gas Turbine |
| | | mum | | | |
| | | Load | | | |
| +ve | 26% | Low | Bleed | Partly | Comparative Example: |
| | | | | Open | Hybrid CTPGS without |
| | | | | | top-up compressor |
| +ve | 20% | Low | Bleed | Partly | Hybrid CTPGS: FIG. 2a |
| | | | | Open | |
| +ve | 15% | Low | Bleed | Partly | Hybrid CTPGS: FIG. 3a |
| | | | | Open | |
| Zero | 0% | 0 | Bleed | Partly | Hybrid CTPGS: FIG. 4 |
| power | | | | Open | |
| − ve | −10% | − ve | Bleed | Partly | Hybrid CTPGS: FIG. 5 |
| | | | | Open | |

Table 1 above summarises, by way of example only, likely power figures for various operating modes of a normal gas turbine, a hybrid CTPGS, and a hybrid CTPGS with a top-up compressor as proposed in accordance with some embodiments. Thus, while a hybrid CTPGS may extend the turn-up and turn-down capability of a normal gas turbine beyond its normal power range of 40-100% (wrt Base load), the present examples show that capability may be further extended in the case of a hybrid CTPGS with a top-up compressor, when the system is suitably configured in the bleed mode, for example, so that the IGV's are selected to provide a suitable GT inlet mass flow rate, a suitable bleed mass flow rate is selected (e.g. using variable valves), suitable pressure ratio's are selected for the respective (appropriately sized) power machinery and any TES and compressed air stores are designed to meet the selected pressure and temperature conditions.

In the injection mode, the turn-up capability of the gas turbine may be extended (e.g. at least 5%, or at least 10%) beyond the base load 100% power figure (eg ISO conditions) that is attainable under the same ambient conditions during a normal power generation mode in which air passes respectively downstream through the compressor, combustor and turbine of the GT system to generate power without any power augmentation step, including any air injection.

In the bleed mode, the turn-down capability of the gas turbine may be extended (e.g. at least 20%, or at least 30%) beyond the minimum load % power figure that is attainable under the same ambient conditions during a normal power generation mode in which air passes respectively downstream through the compressor, combustor and turbine of the GT system to generate power without any bleed of air flow.

In the above examples, mass flow rates, including bleed and injection mass flow rates, pressure ratio's and TES and compressed air store conditions are given merely by way of example only. It will be appreciated that in any system those parameters need to be selected having regard to the operating limits of the power machinery and stores concerned. For example, in the zero and negative power examples given the inlet guide vanes are partly open, but in some GT systems this may be possible with fully open inlet guide vanes. Moreover, the capacities of the respective direct TES's, any indirect TES's and the compressed air store usually need to be relatively evenly matched relative to one another.

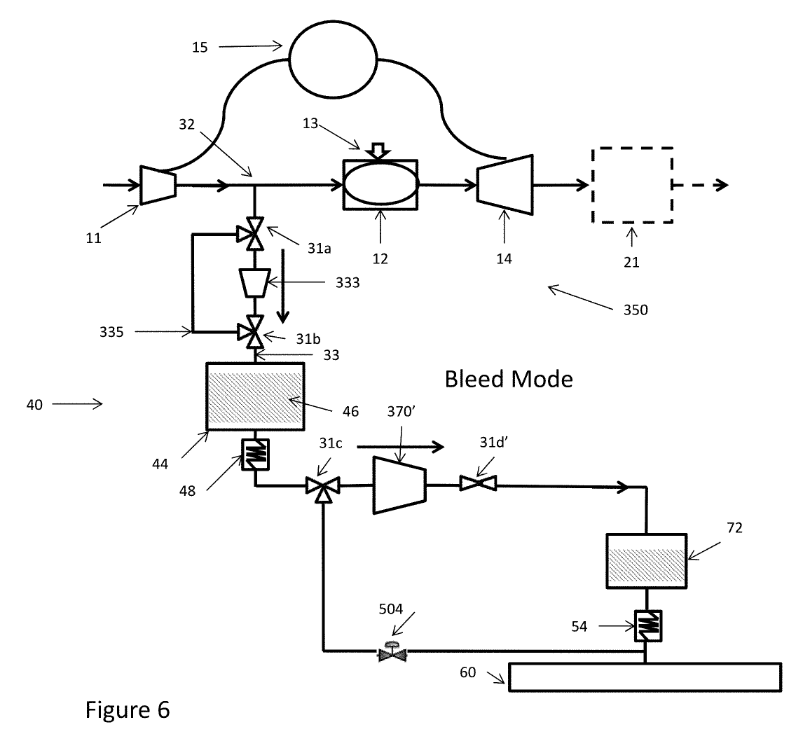

### FIG. 6

This figure shows an embodiment 350 similar to that of FIG. 2a operating in bleed mode, except that there is a reversible second stage compressor/expander 370′ upstream of the second TES 72. In a normal injection mode (not shown), air from the compressed air store 60 will be raised in temperature as it passes through the second TES 72 before expanding (and cooling) in the expander 370′.

However, for use in a boost injection mode where rapid power is required, a throttle valve 504 is provided in an alternative (e.g. parallel) pathway; although the energy of re-expansion is lost in such apparatus, this may be acceptable for a short period of boost running. The throttle valve 504 is located in connection structure that extends directly between the direct TES 40 (including its heat exchanger) and the compressed air store 60 to allow air to pass out from the compressed air store directly to the throttle valve for re-expansion before entering the direct TES 40. Such a valve re-expands the air without significantly changing its temperature and hence such a flow pathway can bypass the second TES 72.

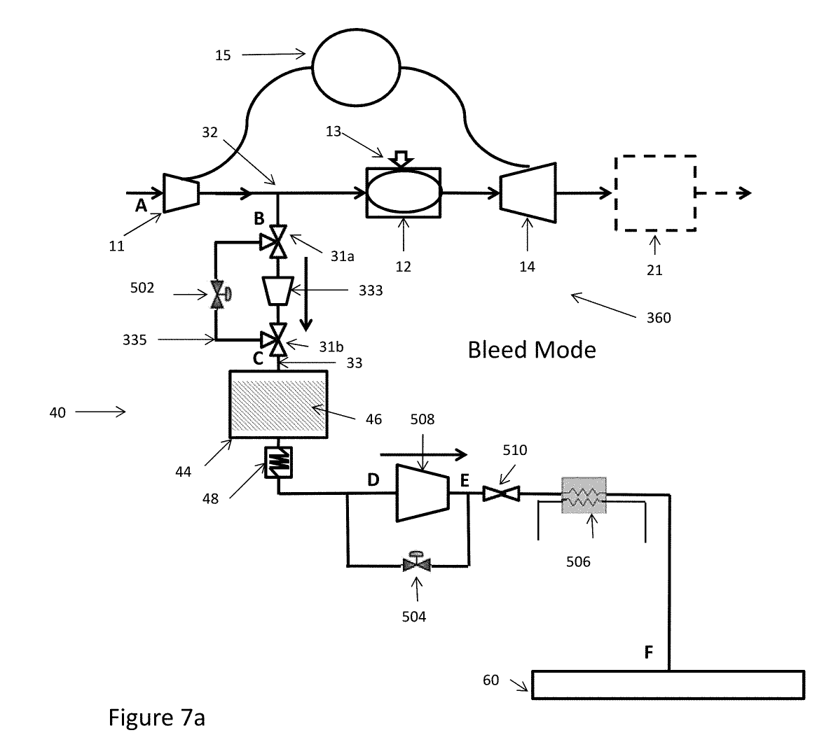

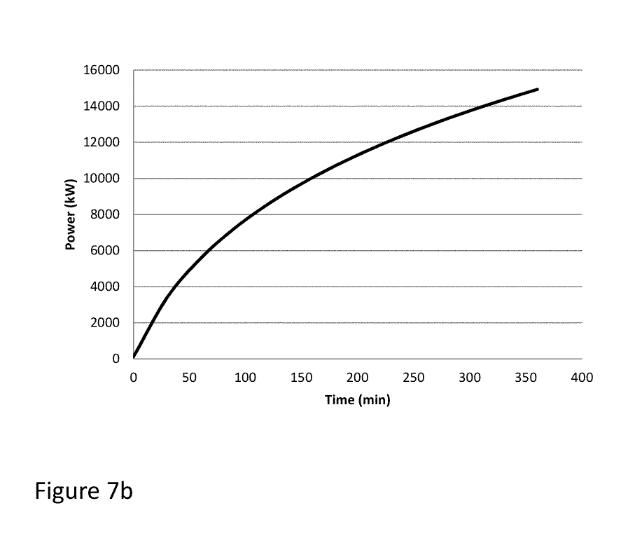

### FIGS. 7a and 7b

FIG. 7a shows a simpler, lower cost system embodiment 360 that does not include a second TES and where the second stage power machinery only includes a compressor 508. In this embodiment, air is shown passing in the bleed mode through an intercooled compressor 508, a shut-off valve 510 (to protect the power machinery from the compressed air store), and an aftercooler 506, before entering the compressed air store 60. In the injection mode (not shown), air passes back from the compressed air store 60 but is expanded by a throttle valve 504 located in an alternative pathway that bypasses the compressor. The system has a lower efficiency due to the heat of compression being discarded, but is a significantly lower cost system that may provide a rapid response, boost injection mode.

The pressure in the compressed air store 60 (e.g. steel pipes) is variable and therefore the intercooler compressor 508 power increases with the time during the Recharge mode. By way of example, a Recharge mode may last for 6 hours, and in that time the maximum compressor power may rise to within the region of 15 MW. FIG. 7b is a graph showing the profile of the power consumption at the intercooler compressor during that Recharge period.

By way of example only, cycle parameters during a recharge mode and boost mode for the FIG. 7a embodiment (modelling based on a GE 9FA turbine) are shown in Table 2 below at respective successive downstream locations A to F, as identified on FIG. 7a.

TABLE 2

| | Parameter | Unit | Recharge Mode | Boost Mode |
|---|---|---|---|---|
| A | Ambient Pressure | bar | 1.01325 | |
| | Ambient Temperature | ° C. | 15 | |
| | Relative Humidity | % | 60 | |
| | Inlet mass flow | kg/s | 400 | 641.78 |
| B | Pressure | bar | 8 or 23.5 | 23.45 |
| | Temperature | ° C. | 286.6 | 522.7 |
| | Bleed Mass flow | kg/s | 50.00 | 50.00 |
| C | Pressure | bar | 23.5 | 23.45 |
| | Temperature | ° C. | 528.0 | 522.7 |
| D | Pressure | bar | 23.45 | 23.50 |
| | Temperature | ° C. | 35.00 | 15.00 |
| E | Pressure | bar | 255.10 | 245.00 |
| | Temperature | ° C. | 129.46 | 15.00 |
| F | Pressure | bar | 250.00 | 250.00 |
| | Temperature | ° C. | 35.00 | 15.00 |
| | Compressor Capacity | kW | 14,926 | — |

The performance of the gas turbine and the complete cycle (including the power consumption of the intercooler compressor) for the FIG. 7a embodiment are shown in Table 3 below in the respective bleed and injection modes and for minimum load and 100% load.

TABLE 3

| | | | | | | CCGT 100% load |
|---|---|---|---|---|---|---|
| | | | Bleed Mode | Injection Mode | CCGT part load | (No bleed, |
| | | | (50 kg/s) | (50 kg/s) | (40% GT load) | No injection) |
| Standard | GT Gross Output | kW | 89,238 | 291,597 | 102,624 | 252,665 |
| Turndown | GT Gross Heat Rate | kJ/kWh | 14,450 | 8,831 | 13,738 | 9,697 |
| | ST Gross Output | kW | 89,971 | 133,486 | 100,289 | 130,288 |
| | CCGT Net Output | kW | 147,743 | 415,394 | 195,475 | 373,704 |
| | Output as percentage | % | 39.5% | 111.2% | 52.3% | 100% |
| | of rated (CCGT) | | | | | |
| | CCGT Net Heat Rate | kJ/kWh | 8,690 | 6,139 | 7,213 | 6,556 |

| | | | |
|---|---|---|---|
| Weighted Average | kJ/kWh | 6,808 | 6,780 |
| CCGT Heat Rate | | | |

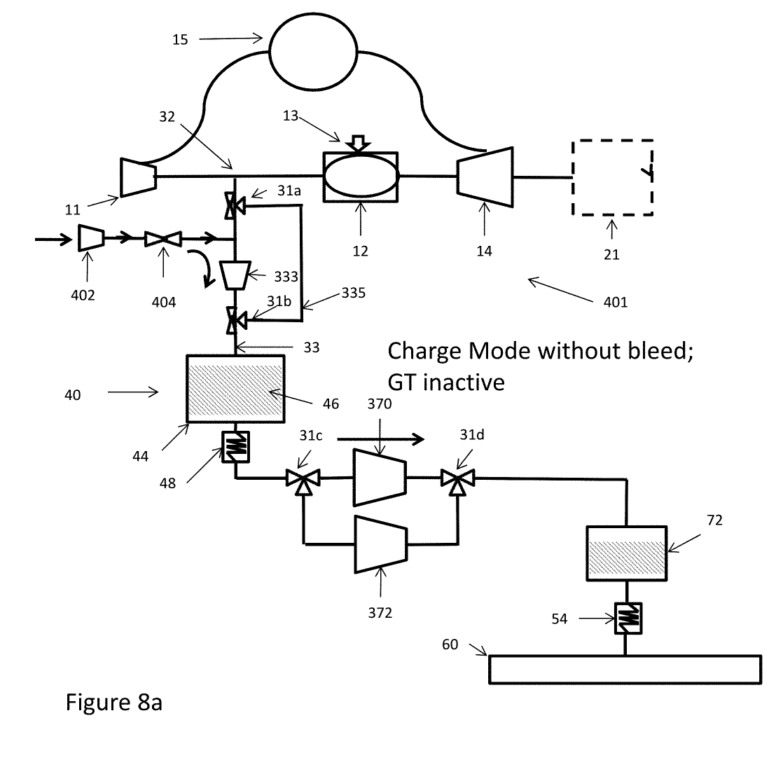

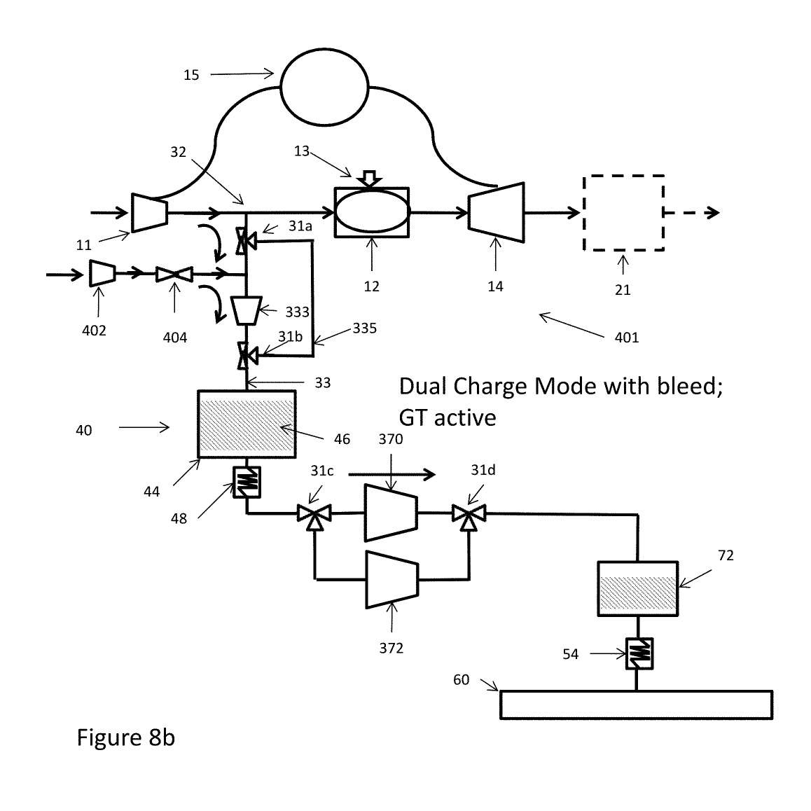

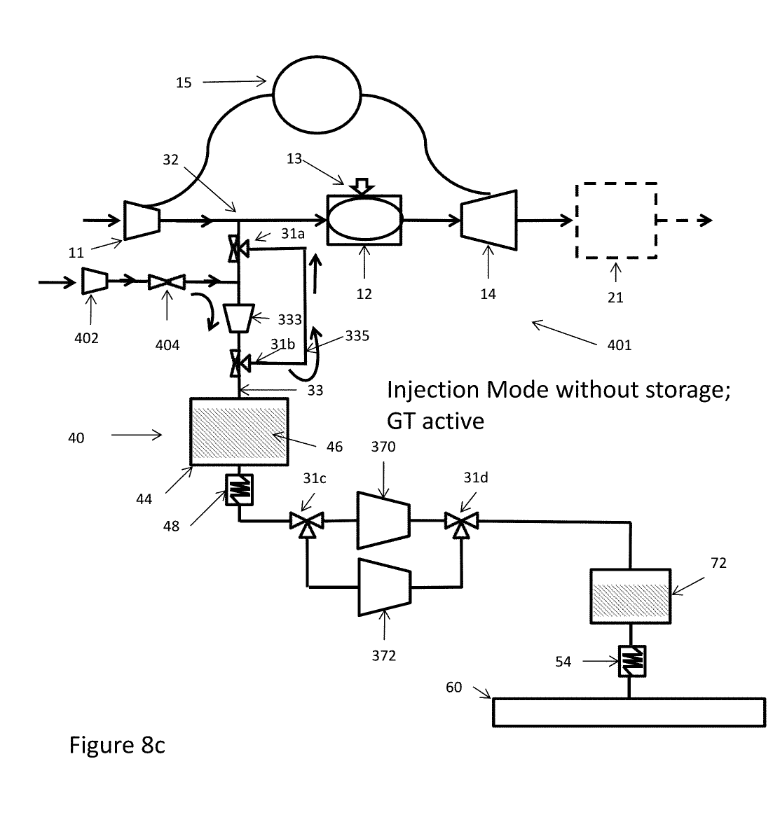

### FIGS. 8a to 8c

These figures show an embodiment 401 similar in principle to FIG. 2a, except that in addition there is a charging compressor 402 that acts (at least) as an alternative first stage compressor feeding the top-up compressor 333 to charge the compressed air store. The presence of charging compressor 402 means that charging of the high pressure compressed air store can occur while the gas turbine is inactive, or, indeed, while it is active but without needing to extract air from the gas turbine.

Charging compressor 402 is disposed in a flow pathway that connects to the main flow passageway network upstream of the top-up compressor 333, and it has its own upstream, external air (e.g. filtered atmospheric air) inlet and a valve 404 downstream of its outlet that acts as an on/off valve.

In FIG. 8a, the gas turbine is shown inactive in a charge mode and all first stage compression is undertaken by the charging compressor 402. Valve 31a is closed and valve 31b is open such that it directs flow towards TES 40. Charging compressor 402 is preferably configured to compress external air over the same pressure ratio as the first compressor (e.g. at low load), but may be a smaller, lower power/cost machine since it need only be sized to match, for example, the maximum (bleed) mass flow rate seen by the top-up compressor 333 and the pressure ratio of the first compressor at low load.

In FIG. 8b, the gas turbine is shown active in a charge mode where bleeding is taking place such that air is supplied from both charging compressor 402 and the first compressor 11, with valves 31a and 31b both open so as to allow downstream flow towards TES 40; for example, the charging compressor may be needed to expedite charging. If a combined feed mode is required, the top-up compressor 333 must also be sized for the maximum combined mass flow rate. Alternatively, a plurality of smaller top-up compressors may be provided in parallel and selectively used in combination to address the different respective mass flow rates.

Thus, multiple charging modes are potentially available which include charging from charging compressor 402, a combination of charging compressor 402 and bleed air from the gas turbine compressor 11, or just bleed air from the latter.

The combination of the charging compressor 402 in series with the downstream top-up compressor 333 means that the system can also provide an alternative source of heated, compressed air for injection into the gas turbine for power augmentation if, for example, the storage system was in an uncharged state. This is possible because the power drawn from the grid to operate both of those compressors is roughly the order of half the power boost obtained in the gas turbine.

One mode of operation is shown in FIG. 8c, where heated, pressurised air compressed successively by the charging compressor 402 and top-up compressor 333 is selectively diverted by the three-way valve 31b along the (usual discharge) bypass pathway 335 in the usual discharge direction before being selectively directed by three-way valve 31a back towards the fluid connections 32, before being injected into the gas turbine to boost mass flow and power.

It will be appreciated that other related modes of operation are possible to meet operating requirements. For example, (i) a combined storage/power augmentation mode might be where some of the above-mentioned heated, pressurised air (generated by the charging compressor and top-up compressor) may be split by valve 31b such that a proportion is sent to storage and the remainder is used to boost gas turbine power, or (ii) valve 31b may direct all the above-mentioned heated, pressurised air along the bypass pathway 335 via directed by three-way valve 31a back towards the fluid connections 32 and gas turbine, but valve 31b may also permit heated, pressurised air returning from storage to supplement that air.

While some embodiments have been described in detail, other embodiments are possible. Therefore, the scope of the appended claims should not be limited to the description of the preferred embodiments contained herein. For example, the CTPGS may be a simple cycle SCGT/open cycle OCGT plant, with only one power cycle and no provision for waste heat recovery, or it may be any known or suitable future variant or derivative thereof which could still benefit from integration of a top-up compressor in the ACAES sub-system, such as a combined cycle gas turbine CCGT (i.e. with a steam turbine bottoming cycle in addition to the topping cycle), or a variant thereof, for example, a CTPGS with intercooling, reheat, recuperation, or with steam injection. Some embodiments further provide any novel combination of the above-mentioned features which the person of ordinary skill would understand as being capable of being combined.

1. A hybrid combustion turbine power generation system (CTPGS), comprising:
a combustion turbine (GT) system including a first compressor, a combustor and a turbine fluidly connected downstream of each other, wherein the turbine and compressor are coupled on a drive shaft and operatively associated with a generator or motor/generator, and an adiabatic compressed air energy storage system (ACAES) integrated therewith via one or more fluid connections disposed between the compressor and turbine, so as to allow air to be extracted from, and injected into, the GT system;
wherein the ACAES includes a flow passageway network and associated valve structure leading from the one or more fluid connections to a compressed air store via a first direct thermal energy store (TES); and,
wherein a top-up compressor is disposed in the flow passageway network between the one or more fluid connections and the direct TES, and is so fluidly connected that its inlet receives air extracted from the GT system and its outlet sends air at a higher temperature and pressure towards the downstream direct TES.

2. The hybrid CTPGS according to claim 1, wherein the ACAES further includes a charging compressor, having an associated air inlet, that is fluidly connected upstream of the top-up compressor, such that an outlet of the charging compressor sends compressed air towards an inlet of the top-up compressor for charging the compressed air store.

3. The hybrid CTPGS according to claim 1, wherein the charging compressor is operable over a similar pressure ratio to that of the first compressor.

4. The hybrid CTPGS according to claim 1, wherein the flow passageway network includes an alternative flow pathway that allows flow to bypass the top-up compressor.

5. The hybrid CTPGS according to claim 1, wherein second stage power machinery is provided in the flow passageway network between the direct TES and the compressed air store, and wherein the second stage power machinery comprises a compressor and a pressure reducing device disposed in alternative respective flow pathways between the at least one direct TES and the compressed air store.

6. (canceled).

7. The hybrid CTPGS according to claim 1, wherein, in an injection mode, returning air follows a flow pathway that bypasses the top-up compressor.

8. The hybrid CTPGS according to claim 1, wherein in the ACAES, in a bleed mode, extracted air is compressed in the top-up compressor and in the second and any subsequent stage power machinery disposed between the direct TES and the compressed air store, but, in an injection mode, returning air is only expanded in the ACAES in power machinery disposed between the compressed air store and the direct TES.

9. The hybrid CTPGS according to claim 1, wherein, during a bleed mode, the top-up compressor raises the air pressure in the direct TES to a selected pressure and, in an injection mode, the second and any subsequent stage power machinery disposed between the direct TES and the compressed air store expand the air so that it returns to the direct TES at substantially the same selected pressure.

10. The hybrid CTPGS according to claim 1, wherein the pressure ratio of the top-up compressor in a bleed mode is selected such that heat is stored in the direct TES at a temperature within 40° C. or less, or 30° C. or less, or 20° C. or less of the first compressor air outlet temperature in the injection mode.

11. The hybrid CTPGS according to claim 1, wherein the pressure ratio of the top-up compressor in a bleed mode is selected such that heat is stored in the direct TES at a temperature of 50° C. or more, or even 80° C. or more, of the first compressor air outlet temperature in the injection mode.

12. The hybrid CTPGS according to claim 1, wherein the second and any subsequent stage power machinery disposed between the direct TES and the compressed air store operates with a greater overall pressure ratio upon expansion in an injection mode than their overall pressure ratio upon compression in a bleed mode, such that the direct TES operates at a lower operating pressure during the injection mode than in the bleed mode.

13. The hybrid CTPGS according to claim 1, wherein the at least one direct TES includes a direct thermal transfer, sensible heat store comprising a gas permeable, solid thermal storage medium disposed in respective, downstream, individually access controlled layers.

14. The hybrid CTPGS according to claim 1, wherein the compressed air store includes a constant pressure, compressed air store.

15. (canceled).

16. (canceled).

17. The hybrid CTPGS according to claim 1, wherein, in a bleed mode, the inlet guide vanes are at least partly open.

18. The hybrid CTPGS according to claim 1, wherein, in a bleed mode, the bleed mass flow rate is at least two times the maximum injection mass flow rate that is achievable in the hybrid CTPGS.

19. A hybrid CTPGS according to claim 1, wherein the apparatus is configured so that, when the hybrid CTPGS is operating in a bleed mode, the total output power of all the power machinery in the hybrid CTPGS, and any steam turbine plant that is coupled downstream to it, is either zero or negative.

20. (canceled).

21. The hybrid CTPGS according to claim 19, wherein, in a bleed mode, the bleed mass flow rate is selected such that the mass flow rate through the gas turbine downstream of the one or more fluid connections is lower than that achievable when the inlet guide vanes are closed and no bleed or injection is occurring in the gas turbine.

22. The hybrid CTPGS according to claim 19, wherein, in a bleed mode, the pressure ratio across the first compressor is at least 10% lower than the normal minimum pressure ratio that is achievable across it when the inlet guide vanes are closed and no bleed or injection is occurring.

23. (canceled).

24. (canceled).

25. A method of operating a hybrid combustion turbine power generation system (CTPGS), wherein the hybrid CTPGS comprises:
a combustion turbine (GT) system including a first compressor, a combustor and a turbine fluidly connected downstream of each other, wherein the turbine and compressor are coupled on a drive shaft and operatively associated with a generator or motor/generator, and an adiabatic compressed air energy storage system (ACAES) integrated therewith via one or more fluid connections disposed between the compressor and turbine, so as to allow air to be extracted from, and injected into, the GT system;
wherein the ACAES includes a flow passageway network and associated valve structure leading from the one or more fluid connections to a compressed air store via a first direct thermal energy store (TES); and,
wherein a top-up compressor is disposed in the flow passageway network between the one or more fluid connections and the direct TES, and is so fluidly connected that its inlet receives air extracted from the GT system and its outlet sends air at a higher temperature and pressure towards the downstream direct TES;
the method comprising:
(i) operating the system in a bleed mode comprising extracting some air via the one or more fluid connections from air passing respectively downstream through the compressor, combustor and turbine of the GT system and supplying the extracted air to the compressed air store of the ACAES system via the direct TES; and,
(ii) operating the system in an injection mode comprising supplementing air passing respectively downstream through the compressor, combustor and turbine of the GT system by injecting, at the one or more fluid connections, pressurised air that is returning from the compressed air store of the ACAES system via the direct TES.

26. The method according to claim 25, wherein, during the bleed mode, the first compressor air outlet temperature is at least 30° C. lower than it is during the

27. (canceled).

28. (canceled).

29. (canceled).

30. (canceled).

31. (canceled).

32. (canceled).

33. (canceled).

34. (cancelled).

35. (canceled).

36. (canceled).

37. (canceled).
